(19) United States
(12) Patent Application Publication
(10) Pub. No.: US 2026/0167546 A1
(43) Pub. Date: Jun. 18, 2026

(54) MOLDING APPARATUS AND MOLDING METHOD

(71) Applicant: CANON KABUSHIKI KAISHA, Tokyo (JP)

(72) Inventor: KOKI SUEOKA, Saitama (JP)

(21) Appl. No.: 19/416,082

(22) Filed: Dec. 11, 2025

(30) Foreign Application Priority Data
Dec. 18, 2024 (JP) 2024-221900

(51) Int. Cl. C03B 11/05; C03B 11/08

(52) U.S. Cl. CPC C03B 11/05; C03B 11/08; C03B 2215/46

(57) ABSTRACT

A molding apparatus includes a first mold, a second mold, and a body mold into which the first mold and the second mold are fittingly inserted. The body mold includes a corner section on a fitting surface with the first mold, the first mold includes an inclined surface in contact with the corner section, when the first mold is moved in a first direction and a molding material is sandwiched between the first mold and the second mold to mold a molded body, a center axis of the first mold and a center axis of the body mold are aligned by the first mold moving in a state in which the corner section and the inclined surface are in contact, and a contact section of the corner section of the body mold with the first mold viewed in the first direction is a circular or an arcuate shape.

### BACKGROUND

### Field of the Technology

The present disclosure relates to a molding apparatus and a molding method for molding a molded body by pressing a heated and softened molding material between a pair of molds disposed to face each other.

### Description of the Related Art

There is a method of molding an optical element such as a lens by softening a molding material such as glass by heating to soften and press-molding the molding material between a pair of molds precisely machined into a predetermined shape. In that case, in order to obtain a highly precise molded body having small optical axis deviation of the optical element, it is important to suppress deviation between axes of molding surfaces of the molds. As a means for achieving this, a method of restricting deviation between axes of the molds with a body mold is disclosed (see, for example, Japanese Patent Laid-Open No. 2011-126758 and Japanese Patent Publication No. H04-55981). The molding method of the related art will now be described with reference to the drawings.

FIG. 22 illustrates a sectional view of a mold for molding a glass material with the method of the related art described in Japanese Patent Laid-Open No. 2011-126758. According to FIG. 22, a pair of an upper mold 201 and a lower mold 202, facing surfaces of which are molding surfaces of an optical element, and a cylindrical body mold 203 into which the upper mold and the lower mold are respectively slid and inserted from upper and lower openings are disclosed. A mold including an annular spacer 204 that is laid on the body mold 203 at the upper end portion of the body mold 203 for thickness adjustment for the optical element is disclosed. The upper mold 201 and the lower mold 202 that slide and fit in the body mold 203 from both end opening sections are maintained in a predetermined positional relation. For that reason, the mold disclosed in Japanese Patent Laid-Open No. 2011-126758 has a function of keeping deviation between the axes of the upper mold 201 and the lower mold 202 at predetermined precision.

FIG. 23 illustrates a sectional view of a molding apparatus that molds a glass material with the method of the related art described in Japanese Patent Publication No. H04-55981. According to FIG. 23, an upper mold support body 212 that holds an upper mold 211 and includes a taper-shaped guide surface 212a at the distal end portion and a lower mold support body 214 that holds a lower mold 213 and is slidable are disclosed. A body mold 215 that fits onto the outer circumference of the lower mold support body 214 and includes, at the distal end portion, a taper-shaped guide surface 215a that fits onto the guide surface 212a of the upper mold holding body and a moving unit that integrally moves the lower mold support body 214 and the body mold 215 are disclosed. In the molding apparatus including these components, the guide surface 212a of the upper mold support body 212 and the guide surface 215a of the body mold 215 come into contact due to upward movement of the lower mold support body 214 and the body mold 215. The body mold 215 follows the upper mold support body 212, whereby the upper mold 211 and the lower mold 213 are maintained in a predetermined positional relation. For that reason, the molding apparatus disclosed in Japanese Patent Publication No. H04-55981 has a function of keeping deviation between the axes of the upper mold 211 and the lower mold 213 at predetermined precision.

However, in recent years, it has been demanded to continuously mold and mass-produce an optical element having reduced optical axis deviation. In the configuration of Japanese Patent Laid-Open No. 2011-126758, occurrence of optical axis deviation is prevented at a molding initial stage in order to slide and fit the upper mold 201 and the lower mold 202 in the body mold 203. However, when the molding is repeated many times, sliding wear progresses, the gap between the body mold 203 and the upper mold 201 and the lower mold 202 gradually widens, restriction accuracy worsens, and the optical axis deviation increases. For example, the gap widens to approximately 10 μm at ten thousand times of the molding and optical axis deviation of approximately 10 μm occurs. In the configuration of Patent Application Publication No. H04-55981, occurrence of optical axis deviation is prevented at a molding initial stage in order to fit the taper-shaped guide surface 212a of the upper support body 212 and the guide surface 215a of the body mold 215. However, sliding wear progresses as the molding is repeated many times, the roundness of a sliding section, which is a taper surface, worsens, restriction accuracy worsens, and the optical axis deviation increases.

### SUMMARY

Considering the matter shown in the above described related art, the present disclosure is directed to providing a molding apparatus and a molding method for, when an optical element is continuously molded and mass-produced, reducing optical axis deviation that can occur due to the continuous molding.

According to an aspect of the present disclosure, there is provided a molding apparatus including: a first mold; a second mold; and a body mold into which the first mold and the second mold are fit and inserted, wherein the body mold includes a corner section on a fitting surface with the first mold, the first mold includes an inclined surface that is in contact with the corner section, when the first mold is moved in a first direction and a molding material is sandwiched between the first mold and the second mold to mold a molded body, a center axis of the first mold and a center axis of the body mold are aligned by the first mold moving in a state in which the corner section of the body mold and the inclined surface of the first mold are in contact, and a contact section of the corner section of the body mold with the first mold viewed in the first direction is provided in one of a circular shape and an arcuate shape.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic sectional view illustrating a state in which a first mold is opened in a molding apparatus according to a first embodiment.

FIG. 2 is a schematic sectional view illustrating a state in which a body mold and the first mold are in contact along a circle centering on the center axis of a convex section in the molding apparatus according to the first embodiment.

FIG. 3 is a schematic sectional view illustrating a state in which the first mold is closed in the molding apparatus according to the first embodiment.

FIG. 4 is a schematic sectional view illustrating a state in which molding has been repeated many times and sliding wear of a corner section has progressed and the state in which the first mold is opened in the molding apparatus according to the first embodiment.

FIG. 5 is a schematic sectional view illustrating the state in which the molding has been repeated many times and the sliding wear of the corner section has progressed and a state in which the body mold and the first mold are in contact along the circle centering on the center axis of the convex section in the molding apparatus according to the first embodiment.

FIG. 6 is a schematic sectional view illustrating the state in which the molding has been repeated many times and the sliding wear of the corner section has progressed and the state in which the first mold is closed in the molding apparatus according to the first embodiment.

FIG. 7 is a schematic perspective view illustrating a shape of the body mold in the first embodiment.

FIG. 8 is a flowchart illustrating a manufacturing process in press-molding an optical element.

FIG. 9 is a schematic sectional view for describing a suitable relation for dimensions of the first mold, the body mold, and a first spacer in the molding apparatus according to the first embodiment.

FIG. 10 is a schematic sectional view illustrating a state in which a first mold is opened in a molding apparatus according to a second embodiment.

FIG. 11A is a top view of a body mold according to a third embodiment.

FIG. 11B is a perspective view of the body mold according to the third embodiment.

FIG. 12 is a schematic sectional view illustrating a state in which a first mold is opened in a molding apparatus according to a fourth embodiment.

FIG. 13 is a schematic sectional view illustrating a state in which a first mold is opened in a molding apparatus according to a fifth embodiment.

FIG. 14 is a schematic sectional view illustrating a state in which the first mold is closed in the molding apparatus according to the fifth embodiment.

FIG. 15 is a schematic sectional view for describing a correction method in the case in which the molding has been repeated many times and sliding wear of a corner section has progressed and deviation between axes has occurred in the molding apparatus according to the fifth embodiment.

FIG. 16 is a schematic sectional view illustrating a state in which the molding has been repeated many times and the sliding wear of the corner section has progressed and a state in which a first spacer and a second spacer has been changed from those before correction and the first mold has been opened before a press operation is performed in the molding apparatus according to the fifth embodiment.

FIG. 17 is a schematic sectional view illustrating the state in which the molding has been repeated many times and the sliding wear of the corner section has progressed and a state in which the first spacer and the second spacer has been changed from those before the correction and the first mold has been closed in the press operation in the fifth embodiment.

FIG. 18 is a schematic sectional view illustrating the state in which the molding has been repeated many times and the sliding wear of the corner section has progressed and a state in which heating has been performed more than before correction and then the first mold has been opened before the press operation is performed in the molding apparatus according to the fifth embodiment.

FIG. 19 is a schematic sectional view illustrating the state in which the molding has been repeated many times and the sliding wear of the corner section has progressed and a state in which heating has been performed more than before correction and then the first mold has been closed in the press operation in the molding apparatus according to the fifth embodiment.

FIG. 20 is a schematic sectional view illustrating the state in which the molding has been repeated many times and the sliding wear of the corner section has progressed and a state in which the second spacer has been changed from that before correction and then a press load has been increased and the first mold has been opened before the press operation is performed in the molding apparatus according to the fifth embodiment.

FIG. 21 is a schematic sectional view illustrating the state in which the molding has been repeated many times and the sliding wear of the corner section has progressed and a state in which the second spacer has been changed from that before correction and then the press load has been increased and the press operation has been performed and the first mold has been closed in the molding apparatus according to the fifth embodiment.

FIG. 22 is a schematic sectional view illustrating a structure in a molding apparatus of the related art.

FIG. 23 is a schematic sectional view illustrating the structure in the molding apparatus of the related art.

FIG. 24A is an exemplification of a mode of use of an optical member obtained by a molding apparatus and is a perspective view of an information terminal mounted with an optical device.

FIG. 24B is a schematic sectional view of an optical device mounted with an optical member that is a molded body obtained by the molding apparatus.

### DESCRIPTION OF THE EMBODIMENTS

Molding apparatuses, molding methods, and the like according to embodiments of the present disclosure are described below with reference to the drawings. Note that the embodiments and examples described below are exemplifications and those skilled in the art can change, for example, detailed configurations as appropriate and carry out the detailed configurations without departing from the gist of the present disclosure.

In the drawings referred to in the description of the embodiments and the examples below, unless specifically noted otherwise, it is assumed that elements denoted by the same reference numerals and signs have the same functions. In the figures, when a plurality of the same elements are disposed, reference numerals and signs may not necessarily be given and the elements may not necessarily be described. Since the figures are schematically expressed for convenience of illustration and description, it is assumed that shapes, sizes, disposition, and the like of elements described in the drawings may not necessarily strictly coincide with real objects.

Note that, in the following description, it is assumed that, for example, an X plus direction being written indicates the same direction as a direction pointed by an X-axis arrow in an illustrated coordinate system and an X minus direction being written indicates a direction 180 degrees opposite to the direction pointed by the X-axis arrow in the illustrated coordinate system. It is assumed that an X direction being simply written has no relation of difference from the direction pointed by the illustrated X-axis arrow and indicates a direction parallel to the X axis. The same applies to directions other than X. Directions described concerning the illustrated components are exemplifications. For example, components disposed side by side in the X plus direction may be disposed side by side in the X minus direction or may be disposed side by side in a direction different from the X direction. A Z direction is often provided to coincide with the vertical direction but may not coincide with the vertical direction.

### First Embodiment

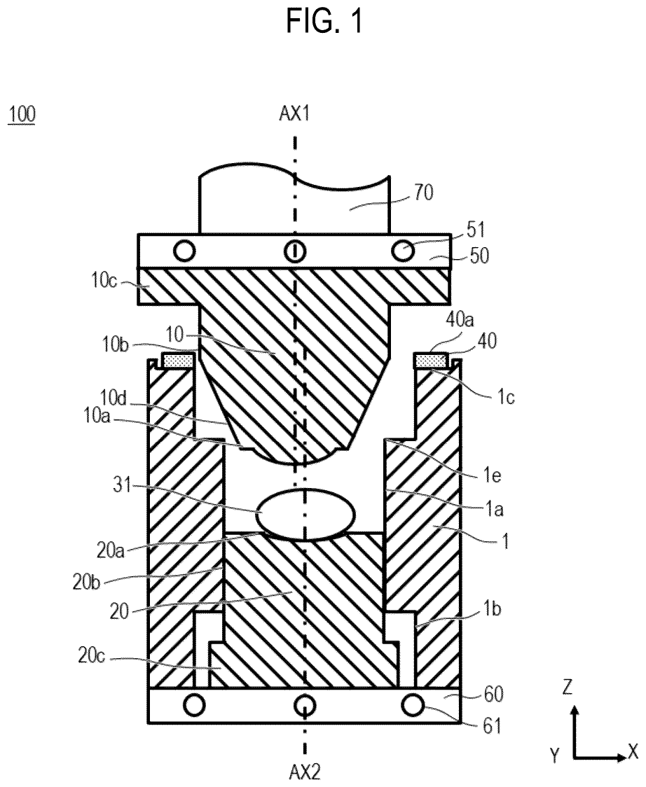

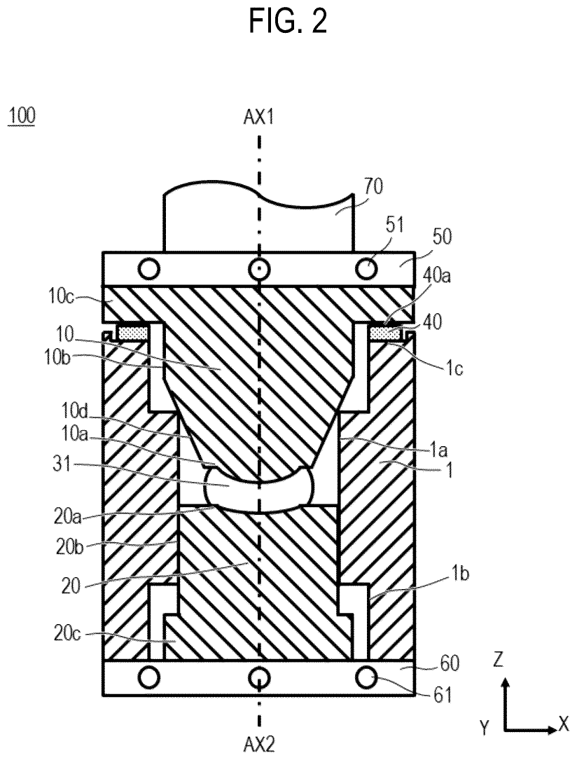

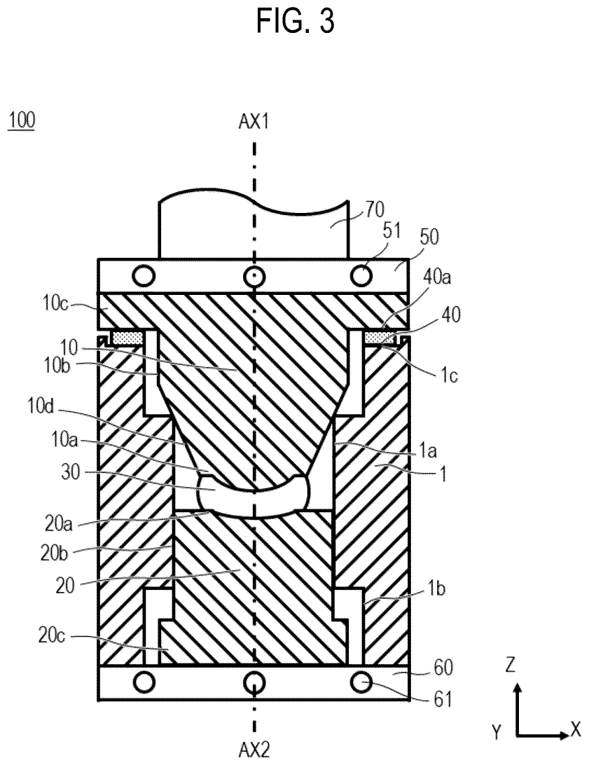

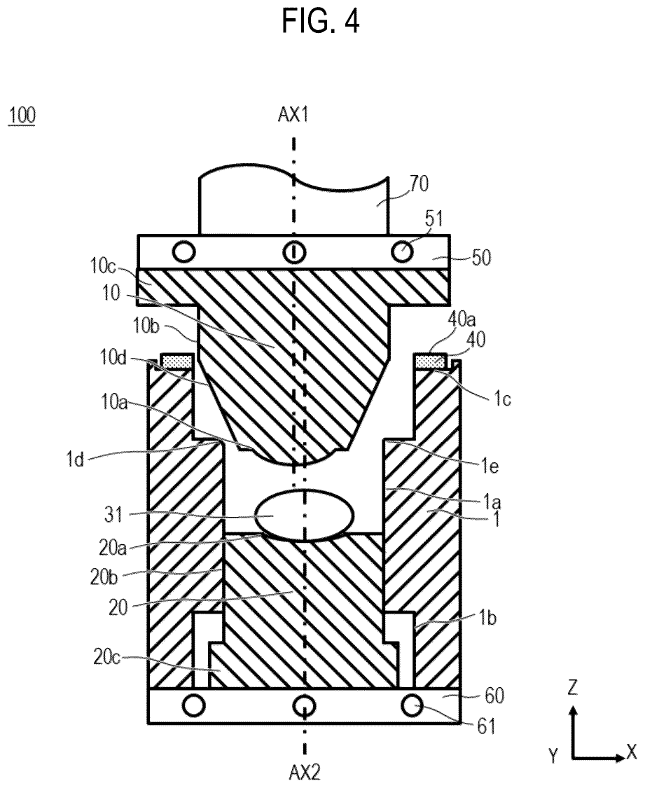

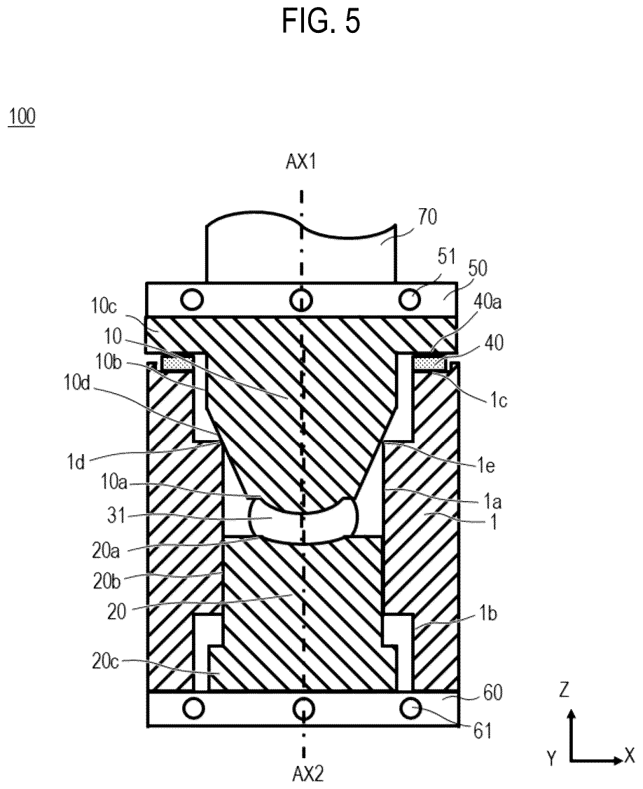

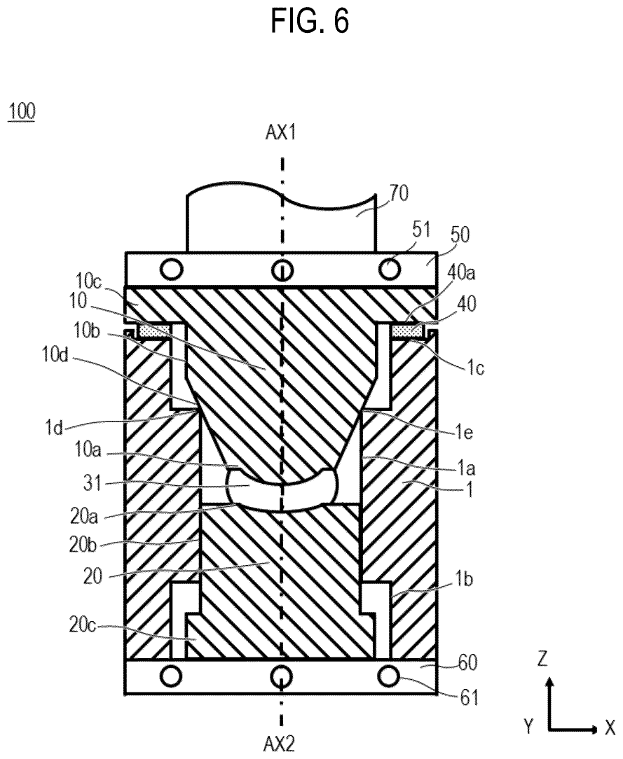

A first embodiment is specifically described with reference to FIGS. 1, 2, 3, 4, 5 and 6. FIG. 1 is a schematic sectional view illustrating a state in which a first mold 10 has been opened before a molding apparatus 100 according to the present embodiment performs a press operation. FIG. 2 is a schematic sectional view illustrating a state in which a body mold 1 and the first mold 10 are in contact along a circle centering on the center axis of a convex section 1a in the press operation in the molding apparatus 100. FIG. 3 is a schematic sectional view illustrating a state in which the first mold 10 is closed in the press operation in the molding apparatus 100. FIG. 4 is a schematic sectional view illustrating a state in which molding has been repeated many times and sliding wear of the convex section 1a has progressed and a state in which the first mold 10 has been opened before the press operation is performed in the molding apparatus 100. FIG. 5 is a schematic sectional view illustrating the state in which the molding has been repeated many times and the sliding wear of the convex section 1a has progressed and the state in which the body mold 1 and the first mold 10 are in contact along the circle centering on the center axis of the convex section 1a in the press operation in the molding apparatus 100. FIG. 6 is a schematic sectional view illustrating the state in which the molding has been repeated many times and the sliding wear of the convex section 1a has progressed and the state in which the first mold 10 is closed in the press operation in the molding apparatus 100.

The molding apparatus 100 according to the first embodiment includes the body mold 1, the first mold 10, a second mold 20, a first spacer 40, a first mold holding member 50, a second mold holding member 60, and a driving source 70. The body mold 1 has one of a substantially cylindrical shape and a substantially frame-like shape and is capable of housing at least a part of the first mold 10 and the second mold 20 on the inside of the body mold 1. In the present embodiment, the second mold 20 is housed and held in an internal space of the body mold 1.

In the present embodiment, the first mold 10 includes a molding surface 10a, a first axis adjustment section 10d, a cylinder section 10b and a brim section 10c further expanded in the outer diameter from the cylinder section 10b, which are disposed from the lower end in the Z minus direction. An upper mold for actually press-molding a molding material 31 is provided on the molding surface 10a. The first axis adjustment section 10d is formed as an inclined surface, the distance of which from a center axis AX1 increases further away from the molding surface 10a. The second mold 20 includes a molding surface 20a, a cylinder section 20b and a brim section 20c further expanded in the outer diameter from the cylinder section 20b, which are disposed from the upper end in the Z plus direction. A lower mold for actually press-molding the molding material 31 is provided on the molding surface 20a.

In the present embodiment, the first mold 10 is held by the first mold holding member 50 at the Z plus direction upper end and connected to the driving source 70 via the first mold holding member 50 and is capable of moving in the Z direction. The second mold holding member 60 holds the second mold 20 and is connected to the body mold 1 such that the second mold 20 is held at a predetermined position inside the body mold 1. At the time of molding, the first mold 10 and the first mold holding member 50 are moved in the Z minus direction by the driving source 70 and fit and inserted into an internal space of the body mold 1 and presses, with predetermined pressure, the molding material 31 placed between the molding surface 10a and the molding surface 20a. Note that, as described below, the first mold 10, the second mold 20 and the body mold 1 that holds the second mold 20 are capable of moving with respect to one another on an XY plane such that automatic adjustment of the center axes of the first mold 10, the second mold 20 and the body mold 1 can be performed.

In the first mold holding member 50 and the second mold holding member 60, a heater 51 and a heater 61 are provided in order to set the first mold 10 and the second mold 20 to temperature suitable for press molding or keep the molding material 31 in a press-moldable softened state. The respective heaters are controlled based on detection results of not-illustrated temperature sensors installed in the first mold 10 and the second mold 20 such that these molds have a predetermined temperature.

A not-illustrated cooling unit is provided in the outer circumferential portion of the body mold 1 in order to open the molds after the pressing of the molding material 31 and cool these molds to temperature at which a molded body 30 (see FIG. 3) can be taken out. For example, a gas introduction pipe for blowing an N₂ gas is installed and it is possible to control a flow rate of the N₂ gas and perform control.

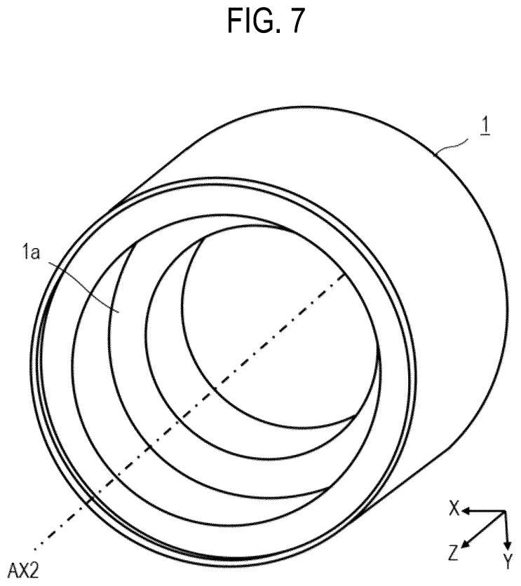

A cylindrical convex section 1a and a cylindrical hole section 1b are provided in the body mold 1. More specifically, as illustrated in FIG. 7, which is a schematic perspective view of the body mold 1, in the present embodiment, the body mold 1 has a cylindrical shape and the hole section 1b is equivalent to an internal space in the cylindrical shape. The cylindrical convex section 1a is formed in a form protruding into the internal space by further reducing a hole diameter in the hole section 1b. The convex section 1a is formed along a center axis AX2 coaxial with the hole section 1b and is provided at a position separated from each of the upper end and the lower end of the hole section 1b at the center axis AX2 direction of the hole section 1b.

The cylinder section 20b of the second mold 20 is fit with the convex section 1a from the minus direction side. The brim section 20c of the second mold 20 is held in a space formed by the hole section 1b and the second mold holding member 60. That is, the second mold 20 is fixed in the XY direction and restricted from moving in the Z direction by the body mold 1 and the second mold holding member 60. The center axis of the second mold 20 is configured to be substantially coaxial with the center axis AX2 of the convex section 1a of the body mold 1. Note that “substantially coaxial” means being coaxial if errors that inevitably occur in manufacturing and assembly are excluded.

The first spacer 40 has a substantially annular shape corresponding to the shape of the cylindrical end portion of the body mold 1 and is placed on a receiving section 1c provided at the upper end in the Z plus direction of the body mold 1. The receiving section 1c includes a flat portion and a portion protruding in the Z plus direction and a moving range in the XY plane of the first spacer 40 is limited by the protruding portion of the receiving section 1c. For this reason, the first spacer 40 does not come off the body mold 1 and drop.

As described above, the first mold 10 is coupled to the first mold holding member 50 and the driving source 70. The first mold 10 is movable in the Z direction along the center axis AX1 from a mold opening position illustrated in FIG. 1 to a mold clamping position illustrated in FIG. 3 by the driving source 70. Here, the mold opening position is a position of the first mold 10 where the brim section 10c separates from the first spacer 40. The mold clamping position is a position of the first mold 10 where the brim section 10c comes into contact with an abutment surface 40a and elastically deforms the first spacer 40. Note that the Z direction in which the first mold 10 moves in performing mold opening and mold clamping can also be referred to as first direction.

Here, to prevent optical axis deviation of the molded body 30 from occurring, the press molding is desirably performed in a state in which the center axis AX1 of the first mold 10 is located coaxially with the center axis AX2 of the convex section 1a of the body mold 1. However, in reality, since the first mold 10 is coupled to the driving source 70 for generating a large press pressure and performs a reciprocating motion in the Z direction, even if initial setting is performed such that the center axis AX1 is coaxial with the center axis AX2, deviation between the axes occurs while the molding apparatus 100 repeats the molding operation. In line with such reality, in FIG. 1, a state in which the center axis AX1 of the first mold 10 deviates from the center axis AX2 of the body mold 1 is illustrated. Note that, although a state in which the center axis AX1 of the first mold 10 deviates in the X minus direction with respect to the center axis AX2 of the body mold 1 is illustrated in the figure, this is an example. A state in which the center axis AX1 deviates in one of the X plus direction and the Y direction with respect to the center axis AX2 can also occur.

Here, shapes and a positional relation of the body mold 1 and the first mold 10 in the present embodiment are described. As described above, the cylindrical convex section 1a, the inner diameter of which is fixed, is provided in the body mold 1. A corner section 1e continuous in a circular shape formed by a cylinder inner circumferential surface extending at the center axis AX2 direction and a plane terminating the cylinder inner circumferential surface is formed at the Z plus direction upper end of the convex section 1a. The first axis adjustment section 10d further inclined to the center axis AX1 side toward the Z minus direction (at a position closer to the molding surface 10a) is provided in a portion facing the corner section 1e of the convex section 1a in the Z minus direction of the first mold 10. The center of the first axis adjustment section 10d is substantially located on the center axis AX1 of the first mold 10. Note that “substantially” described here means being located on the center axis if errors that inevitably occur in manufacturing and assembly are excluded. The shape of the first axis adjustment section 10d is desirably symmetrical to the center axis AX1 of the first mold 10. In the present embodiment, an inverted truncated cone shape formed by a taper surface inclined with respect to the center axis AX1 is adopted.

In the molding apparatus according to the present embodiment having the configuration described above, the first mold 10 is moved in the Z minus direction from a mold opened state illustrated in FIG. 1 toward a mold clamped state illustrated in FIG. 3. In this case, first, the taper surface of the first axis adjustment section 10d of the first mold 10 comes into contact with the corner section 1e of the body mold 1. When the first mold 10 is further moved in the Z minus direction, since the first axis adjustment section 10d and the corner section 1e are in contact, stress in the X plus direction is generated in the first mold 10 and stress in the X minus direction is generated in the body mold 1. Accordingly, one of the first mold 10 and the body mold 1 moves such that the center axis AX1 of the first mold 10 and the center axis AX2 of the convex section 1a of the body mold 1 are brought close to each other. At an instance when the first axis adjustment section 10d and the convex section 1a come into contact for the first time, the first mold 10 and the body mold 1 are in contact at one point. However, in the state illustrated in FIG. 2, the first mold 10 and the body mold 1 are in contact as very narrow surfaces formed along a circle parallel to the XY plane.

When the first mold 10 is further moved in the Z minus direction from this state, while the first mold 10 elastically deforming the corner section 1e, the brim section 10c of the first mold 10 comes into contact with and elastically deforms the abutment surface 40a of the first spacer 40 and the first mold 10 reaches the mold clamped state illustrated in FIG. 3. Therefore, when the press of the molding material 31 is completed, the center axis AX1 of the first mold 10, the center axis AX2 of the convex section 1a of the body mold 1, and the center axis of the second mold 20 are substantially coaxial.

Next, a case in which press molding has been performed in the mold opened state and a state in which the molding has been repeated many times and sliding wear of the corner section 1e has progressed and a sliding wear section 1d is formed in a part of the corner section 1e as illustrated in FIG. 4 is described. When the first mold 10 is moved in the Z minus direction from the mold opened state illustrated in FIG. 4 toward a mold clamped state illustrated in FIG. 6, as illustrated in FIG. 5, the first axis adjustment section 10d and the corner section 1e including the sliding wear section 1d come into contact first. When the first mold 10 is further moved in the Z minus direction from this state, the corner section 1e elastically deforms but the corner section 1e facing the sliding wear section 1d in the XY plane has a smaller contact area. For this reason, stress increases, an elastic deformation amount of the corner section 1e increases, and a shape of the corner section 1e after the elastic deformation is close to the shape of the sliding wear section 1d. Therefore, one of the first mold 10 and the body mold 1 moves such that the center axis AX1 of the first mold 10 and the center axis AX2 of the convex section 1a of the body mold 1 are brought close to each other, deviation between the axes is suppressed, and the first mold 10 reaches the mold clamped state illustrated in FIG. 6. For this reason, compared with the schemes of the related art described in Japanese Patent Laid-Open No. 2011-126758 and Japanese Patent Publication No. H04-55981, it is possible to substantially reduce occurrence of deviation between the axes even when an optical element is continuously molded and mass-produced.

According to the present embodiment, when the first mold 10 is moved in the first (Z minus) direction to come close to the second mold 20 held by the body mold 1, one of the first mold 10 and the body mold 1 moves in a direction intersecting the first direction and moves in a direction in which the center axis of the first mold 10 and the center axis of the body mold 1 are brought close to each other. Sliding friction occurs in a part of the body mold 1, for example, due to continuous molding. In such a case, for example, when the first mold 10 deviates in a direction in which the wear has occurred and is moved in the Z minus direction, displacement from an initial state with respect to the center axis AX2 of the convex section 1a of the body mold 1 occurs for the center axis AX1 of the first mold 10. According to the present embodiment, by using elastic deformation of the corner section 1e that occurs with applied pressure smaller than applied pressure at the time of the press molding, in the mold clamped state, the positions of the first mold 10 and the body mold 1 are automatically adjusted such that the center axis AX1 and the center axis AX2 are brought close to each other. For this reason, even at the time of the continuous molding, it is possible to press the molding material 31 in a state in which occurrence of deviation between the axes of the first mold 10 and the second mold 20 is suppressed and open the molds and take out the molded body 30 after performing cooling. Therefore, for example, even when sliding wear occurs in the body mold 1, it is possible to continuously mass-produce a press-molded product having extremely small optical axis deviation.

### Example 1

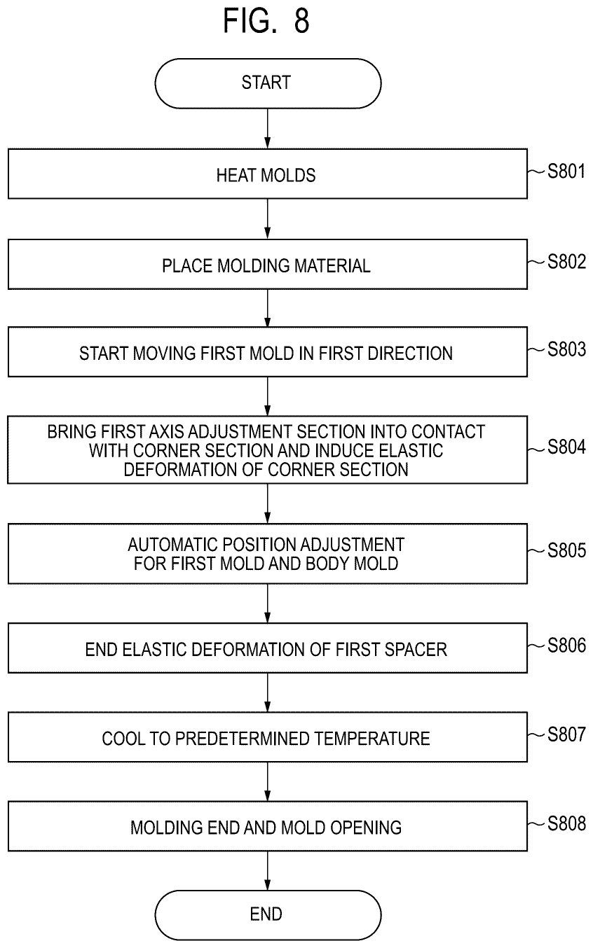

Next, a specific implementation mode of the first embodiment is described as an example 1 below. In the example 1, optical glass serving as a molding material is press-molded and an optical element serving as a molded body is manufactured using the molding apparatus described with reference to FIGS. 1, 2 and 3. A press molding process is performed in an N₂ gas atmosphere in order to prevent oxidation of the molds and the apparatus. A molding method for an optical element executed using the molding apparatus described above is described below with reference to FIG. 8.

First, the brim section 10c of the first mold 10 is set in a state of being separated from the first spacer 40. Molding processing is started in this state. In step S801, the first mold 10, the second mold 20, the body mold 1 and the first spacer 40 are heated by a not-illustrated control unit in the molding apparatus to a predetermined temperature using the heater 51 and the heater 61.

Subsequently, in step S802, by a not-illustrated hand an optical glass material is placed with high position accuracy as the molding material 31 at the center of the molding surface 20a of the second mold 20. Thereafter, the first mold 10, the second mold 20, the body mold 1 and the first spacer 40 are heated to press temperature by the heater 51 and the heater 61. These components are retained at the temperature.

After the heating, in step S803, the driving source 70 moves the first mold 10 and the first mold holding member 50 in the Z minus direction. When the movement is continued, the first axis adjustment section 10d of the first mold 10 comes into contact with the corner section 1e of the body mold 1. When the first mold 10 is further moved in the Z minus direction from this state, as illustrated in step S804, the corner section 1e starts elastic deformation. Substantially simultaneously, stress in the X plus direction is generated in the first mold 10 and stress in the X minus direction is generated in the body mold 1. As illustrated in step S805, the stresses achieve automatic position adjustment for each of the first mold 10 and the body mold 1 to move one of the first mold 10 and the body mold 1 such that the center axis AX1 of the first mold 10 and the center axis AX2 of the convex section 1a of the body mold 1 are brought close to each other.

As illustrated in FIG. 2, the first mold 10 and the body mold 1 respectively move until the center axis AX1 of the first mold 10 and the center axis AX2 of the convex section 1a of the body mold 1 substantially coincide. In that case, the first mold 10 and the corner section 1e come into a state of being in contact with each other as very narrow annular surfaces formed along the circle centering on the center axis of the convex section 1a. Thereafter, when the first mold 10 is moved in the Z minus direction, the corner section 1e further elastically deforms.

When the first mold 10 is further moved in the Z minus direction, the brim section 10c of the first mold 10 comes into contact with the abutment surface 40a of the first spacer 40 and, as illustrated in step S806, the first spacer 40 elastically deforms due to a press load and the first mold 10 reaches the mold clamped state illustrated in FIG. 3. When a press load is applied to the first mold 10 while the first mold 10 being moved in the Z minus direction, the molding material 31 is sandwiched between the molding surface 10a of the first mold 10 and the molding surface 20a of the second mold 20 and pressed. The shape of the optical element is transferred to the molding material 31.

When the molding material 31 is pressed to predetermined thickness and the press molding ends, a press pressure is maintained or the press pressure is switched to lower pressure and the molding method shifts to a cooling process. In step S807, the first mold 10, the second mold 20, the body mold 1 and the first spacer 40 are cooled by the N₂ gas supplied through the not-illustrated N₂ introduction pipe as described above. A flow rate of the N₂ gas is controlled by, for example, supplying the N₂ gas through a mass-flow controller and the flow rate is controlled such that the cooling is performed at an appropriate cooling rate.

Here, in order to prevent the optical element, which is the molded body, from contracting and being separated from the molding surface 10a of the first mold 10 and the molding surface 20a of the second mold 20 while the molds are opened and the molded body 30 is cooled to temperature at which the molded body 30 can be taken out, the press pressure is maintained or is switched to high pressure. At a point in time when the temperature of the molded body 30 has reached a predetermined temperature equal to or lower than the glass transition point, the pressure applied to the first mold 10 by the driving source 70 is released and cooling is further performed as necessary. At a point in time when the temperature of the molded body 30 has reached a predetermined temperature at which the molded body 30 can be taken out, in step S808, the first mold 10 is moved in the Z plus direction by the driving source 70 and mold opening is performed. Then, the molded body 30 is taken out from the molding surface 20a of the second mold 20 by a not-illustrated hand and the molding is ended.

An optical element, which is a molded product, having high shape accuracy is mass-produced by repeating the series of operations described above. For example, a bi-aspheric concave meniscus lens is molded using a glass material having a transition point of 510° C. In that case, as the material of the first mold 10, the second mold 20, the body mold 1 and the first spacer 40, any one of cemented carbide, stainless steel and ceramics is desirably used in order to withstand a high-pressure press load.

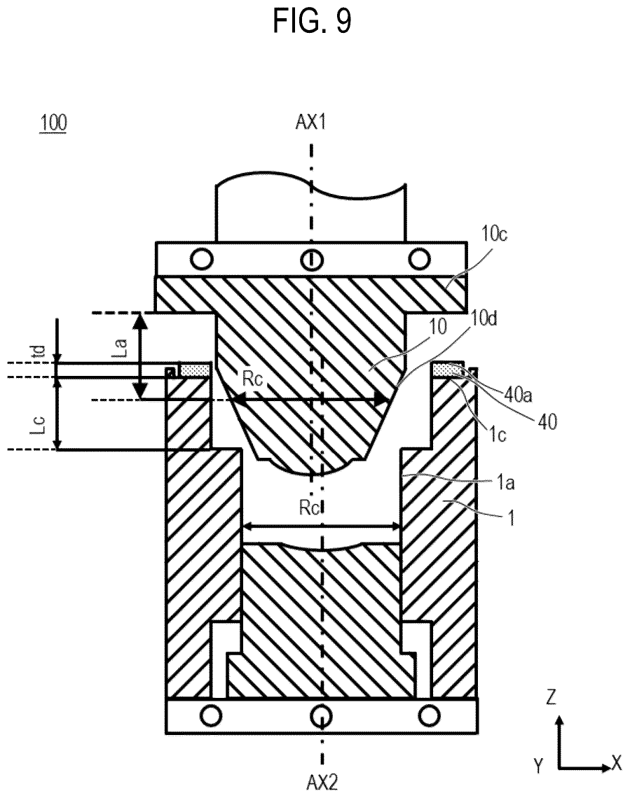

As described above, the center axis AX1 of the first mold 10 and the center axis AX2 of the convex section 1a of the body mold 1 substantially coincide when the first mold 10 and the corner section 1e are in contact on the very narrow annular surfaces along the circle centering on the center axis of the convex section 1a. For this reason, simultaneously with this or after this, it is better that the brim section 10c of the first mold 10 and the abutment surface 40a of the first spacer 40 come into contact and a press load is applied to elastically deform the corner section 1e and the first spacer 40. Here, as illustrated in FIG. 9, when the inner diameter of the convex section 1a is Rc, the distance from a position where the outer diameter of the first axis adjustment section 10d of the first mold 10 is Rc to a contact surface of the brim section 10c with the first spacer 40 in the Z direction is represented as La. The distance from a position of the corner section 1e where the body mold 1 is in contact with the first axis adjustment section 10d to a contact surface of the receiving section 1c with the first spacer 40 in the Z direction is represented as Lc. In this case, in order to obtain the effects described above, thickness td of the first spacer 40 desirably satisfy the following Expression 1.

$$td \leq La - Lc \qquad ( Expression 1 )$$

When an elastic deformation amount of the first spacer 40 is set to a value equal to or smaller than 0.5 μm, an elastic deformation amount of the corner section 1e of the body mold 1 decreases. For that reason, when molding has been repeated many times and sliding wear of the corner section 1e has progressed, the first mold 10 and the corner section 1e cannot necessarily come into contact along a circle centering on the center axis AX2 of the convex section 1a (the entire region of the corner section 1e). In such a case, the center axis AX1 of the first mold 10 and the center axis AX2 of the convex section 1a of the body mold 1 cannot be caused to substantially coincide. On the other hand, when the elastic deformation amount of the first spacer 40 is set to a value equal to or larger than 300 μm, the elastic deformation amount of the corner section 1 e of the body mold 1 increases and generated stress exceeds the strength and the corner section 1e is likely to be broken. For that reason, the material and the shape of the first spacer 40 are desirably selected such that the elastic deformation amount of the first spacer 40 is 0.5 μm to 300 μm.

In order to obtain the effects described above, one of the first mold 10 and the body mold 1 is required to be easily movable in a state in which the first axis adjustment section 10d of the first mold 10 is in contact with the corner section 1e of the body mold 1 such that the center axis AX1 of the first mold 10 and the center axis AX2 of the convex section 1a of the body mold 1 are brought close to each other. For this reason, a coefficient of friction of the first mold 10 and the body mold 1 can be smaller. In general, when pieces of metal having the same material are rubbed, a coefficient of friction increases. Therefore, the first mold 10 and the body mold 1 are desirably respectively combinations of different kinds of materials.

The center axis of the second mold 20 is configured to be substantially coaxial with respect to the center axis AX2 of the convex section 1a of the body mold 1. However, in reality, a gap for fitting the second mold 20 and the body mold 1 has to be provided and deviation between the axes occurs because of the gap. As the deviation between the axes, for example, for example, a difference in a coefficient of thermal expansion of the materials of these components can be used. Specifically, when the second mold 20 and the body mold 1 are heated, the gap between the second mold 20 and the body mold 1 should decrease due to thermal expansion. That is, a coefficient of thermal expansion of the second mold 20 is desirably larger than a coefficient of thermal expansion of the body mold 1.

Note that a control temperature for the first mold 10, the second mold 20, the body mold 1 and the first spacer 40 and a press pressure applied from the driving source 70 to the first mold 10 are set as appropriate depending on a type of a molding material in use and a shape of a molded product.

As an example, the temperature of the first mold 10, the second mold 20, the body mold 1 and the first spacer 40 is set to first temperature (for example, 460° C.) (step S801) and, then, glass serving as the molding material 31 is set in these molds (step S802). Then, these members are heated to second temperature (for example, 570° C.) higher than the first temperature and the viscosity of the molding material 31 is reduced to a state suitable for molding. The molding material 31 is pressed at a first load (for example, a load of 4000 N) (steps S803 to S806). At a point in time when the molding material 31 has been pressed to fixed thickness, the molding method shifts to a cooling process (step S807). At a point in time when the temperature of the first mold 10 and the second mold 20 has reached third temperature (for example, 550° C.) lower than the second temperature, a second load (for example, 6000 N) is applied from the first mold 10 to the molded body 30. The cooling is continued in this state and the pressure from the first mold 10 is released at a point in time when the temperature of the first mold 10 and the second mold 20 has reached temperature (for example, 480° C.) lower than the third temperature. Thereafter, at a point in time when the first mold 10 and the second mold 20 have been cooled to fifth temperature (for example, 460° C.) lower than the fourth temperature, the first mold 10 is moved in the Z plus direction to open the mold and the molded body 30 is taken out (step S808).

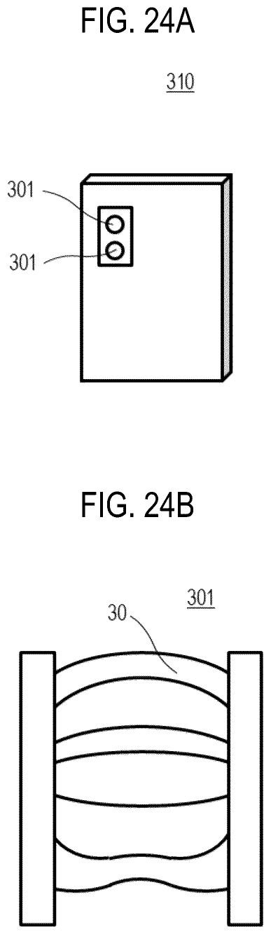

The molded body 30 formed in the molding process described above can be used in an interchangeable lens and a lens mounted on an information terminal. An example in which an optical element, which is the molded body 30, is used as a lens is described with reference to FIGS. 24A and 24B. FIGS. 24A and 24B schematically illustrate an example of an information terminal 310 such as a smartphone in which the optical element (the molded body 30) is used and an example of a lens unit 301 mounted on the information terminal 310 are schematically illustrated. Two lens units 301 are provided in the exemplified information terminal 310. Optical elements (molded bodies 30) are used in the respective lens units 301.

### Second Embodiment

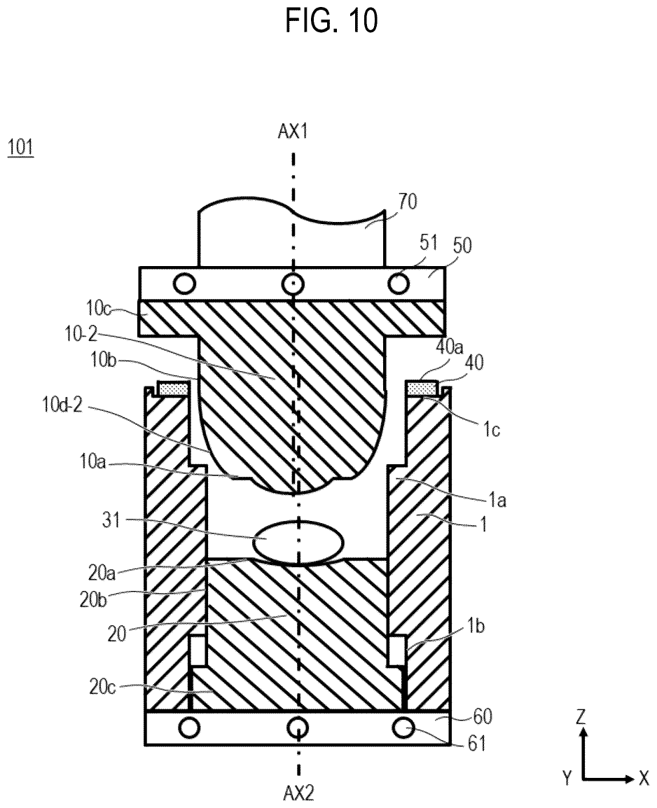

A second embodiment is described with reference to FIG. 10. FIG. 10 is a schematic sectional view illustrating a state in which a first mold 10-2 is opened in a molding apparatus 101 according to the second embodiment. Note that, in the present embodiment, the same components as the components in the first embodiment are denoted by the same reference numerals and signs and description of the components is simplified or omitted here.

In the first embodiment, the portion formed by the surface facing the Z minus direction end portion (the lower end portion) of the first mold 10, that is, the first axis adjustment section 10d facing the corner section 1e has the inverted truncated cone shape formed by the taper surface inclined with respect to the center axis AX1. In contrast, in a first axis adjustment section 10d-2 in the present embodiment, a slope forming a side portion at the time when the first axis adjustment section 10d-2 is cut along the axial direction is not linear but is formed in an R shape. The center axis of the first axis adjustment section 10d-2 is substantially located on the center axis AX1 of a first mold 10-2.

In the present embodiment, when the first mold 10-2 is moved in the Z minus direction from the state illustrated in FIG. 10, the first axis adjustment section 10d-2 of the first mold 10-2 comes into contact with the corner section 1e of the body mold 1. The first mold 10-2 is further moved in the Z minus direction. Then, stress in the X plus direction is generated in the first mold 10-2 and stress in the X minus direction is generated in the body mold 1. One of the first mold 10-2 and the body mold 1 moves such that the center axis AX1 of the first mold 10-2 and the center axis AX2 of the convex section 1a of the body mold 1 are brought close to each other.

When the first mold 10-2 is further moved in the Z minus direction, the first mold 10-2 and the body mold 1 come into contact with the entire region of an annular surface including a circle parallel to the XY plane and the center axis AX1 of the first mold 10-2 and the center axis AX2 of the convex section 1a of the body mold 1 substantially coincide. Therefore, when the pressing of the molding material 31 is completed, the center axis AX1 of the first mold 10-2, the center axis AX2 of the convex section 1a of the body mold 1, and the center axis of the second mold 20 are substantially coaxial.

In the present embodiment as well, when molding is repeated many times, sliding wear of the corner section 1e progresses and a sliding wear section is formed. Even in such a state, as in the first embodiment, at the corner section 1e of a portion facing the sliding wear section, a contact section with the first axis adjustment section 10d-2 is larger than the sliding wear section. Thus, an elastic deformation amount of the portion increases. As a result, since one of the first mold 10-2 and the body mold 1 moves such that the center axis AX1 of the first mold 10-2 and the center axis AX2 of the convex section 1a of the body mold 1 are brought close to each other, deviation between the axes is suppressed. For this reason, compared with the schemes of the related art described in Japanese Patent Laid-Open No. 2011-126758 and Japanese Patent Publication No. H04-55981, it is possible to substantially reduce possibility of occurrence of deviation between the axes even when an optical element is continuously molded and mass-produced.

In the present embodiment as well, the first mold 10-2 is moved in the first (Z minus) direction to come close to the second mold 20 held by the body mold 1. In that case, one of the first mold 10-2 and the body mold 1 moves in a direction intersecting the first direction and moves in a direction in which the center axis of the first mold 10-2 and the center axis of the body mold 1 are brought close to each other. For example, it could occur that sliding wear occurs in a part of the body mold 1 due to continuous molding and, as a result, the center axis AX1 of the first mold 10-2 is displaced with respect to the center axis AX2 of the convex section 1a of the body mold 1. According to the present embodiment, by using elastic deformation of the corner section 1e that occurs with applied pressure smaller than applied pressure at the time of press molding, in the mold clamped state, the positions of the first mold 10-2 and the body mold 1 are automatically adjusted such that the center axis AX1 and the center axis AX2 are brought close to each other. For this reason, even at the time of the continuous molding, it is possible to press the molding material 31 in a state in which occurrence of deviation between the axes of the first mold 10-2 and the second mold 20 is suppressed and open the molds and take out the molded body 30 after performing cooling. Therefore, for example, even when sliding wear occurs in the body mold 1, it is possible to continuously mass-produce a press-molded product having extremely small optical axis deviation.

### Third Embodiment

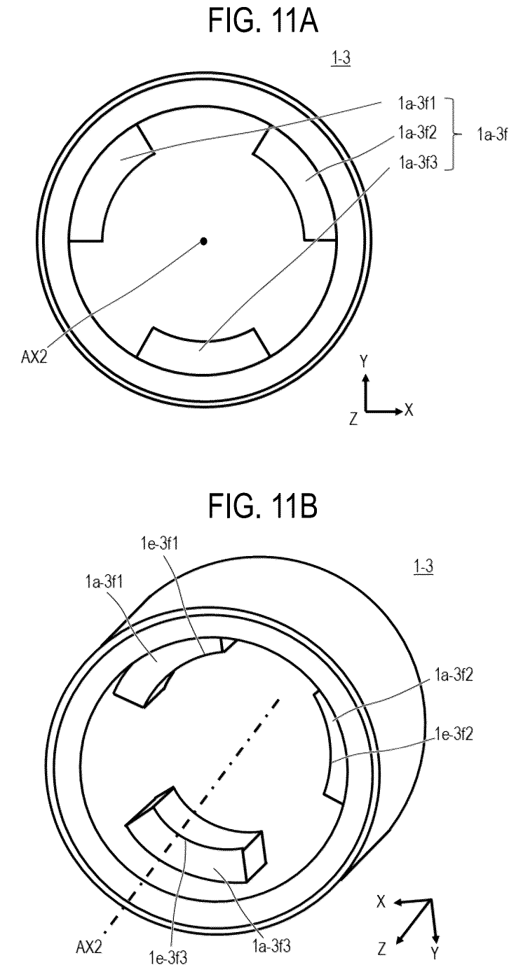

A third embodiment is described with reference to FIGS. 11A and 11B.

FIG. 11A is a top view in which the upper surface of a body mold 1-3 in the present embodiment is viewed from the first mold 10 side (the Z plus direction side). FIG. 11B is a perspective view in which the upper surface of the body mold 1-3 is obliquely viewed. Note that, in the present embodiment, the same matters as the matters in the first embodiment are denoted by the same reference numerals and signs and description of the matters is simplified or omitted.

The present embodiment is the same as the first embodiment in that a corner section is provided in a body mold but is different from the first embodiment in the shape of the corner section and is also different in a form in which the first mold 10 and the corner section are in contact. A convex section 1a-3f in the present embodiment includes protruding sections 1a-3f1, 1a-3f2 and 1a-3f3 corresponding to portions in a cylindrical shape centering on the center axis AX2. Note that, in an illustrated example, the protruding sections 1a-3f1, 1a-3f2 and 1a-3f3 are symmetrically disposed in three places by being shifted by 120 degrees from one another when viewed in a rotation coordinate to be symmetrical centering on the center axis AX2. However, protruding sections may be provided in four or more places as long as the protruding sections are symmetrically disposed. The protruding sections 1a-3f1, 1a-3f2 and 1a-3f3 respectively include corner sections 1e-3f1, 1e-3f2 and 1e-3f3 located on the Z direction plus side at the time of use.

In the present embodiment as well, when the first mold 10 is moved in the Z minus direction, the first mold 10 and the body mold 1-3 come into contact along the corner sections 1e-3f1, 1e-3f2 and 1e-3f3 present in a circle parallel to the XY plane. Therefore, when pressing for the molding material 31 is completed, the center axis AX1 of the first mold 10, the center axis AX2 of the convex section 1a-3f of the body mold 1, and the center axis of the second mold 20 are substantially coaxial.

In the present embodiment as well, when molding is repeated many times, sliding wear progresses in any one of the corner sections 1e-3f1, 1e-3f2 and 1e-3f3 and a sliding wear section is formed. Even in such a state, as in the first embodiment, a contact section with the first axis adjustment section 10d has a contact surface smaller than a contact surface of the sliding wear section at a corner section of a protruding section different from the sliding wear section. Thus, an elastic deformation amount of the portion increases. As a result, since one of the first mold 10 and the body mold 1-3 moves such that the center axis AX1 of the first mold 10 and the center axis AX2 of the protruding sections 1a-3f1, 1a-3f2 and 1a-3f3 of the body mold 1 are brought close to each other, deviation between the axes is suppressed. For this reason, compared with the schemes of the related art described in Japanese Patent Laid-Open No. 2011-126758 and Japanese Patent Publication No. H04-55981, it is possible to substantially reduce possibility of occurrence of deviation between the axes even when an optical element is continuously molded and mass-produced.

In the present embodiment as well, the first mold 10 is moved in the first (Z minus) direction to come close to the second mold 20 held by the body mold 1. In that case, one of the first mold 10 and the body mold 1-3 moves in a direction intersecting the first direction and moves in a direction in which the center axis of the first mold 10 and the center axis of the body mold 1-3 are brought close to each other. For example, it could occur that sliding wear occurs in a part of the body mold 1-3 due to continuous molding and, as a result, the center axis AX1 of the first mold 10 is displaced with respect to the center axis AX2 of the protruding sections 1a-3f1, 1a-3f2 and 1a-3f3 (the convex section 1a-3f) of the body mold 1-3. According to the present embodiment, elastic deformation of the corner sections 1e-3f1, 1e-3f2 and 1e-3f3 that occurs with applied pressure smaller than applied pressure at the time of press molding is used. Accordingly, in the mold clamped state, the positions of the first mold 10 and the body mold 1 are automatically adjusted such that the center axis AX1 and the center axis AX2 are brought close to each other. For this reason, even at the time of the continuous molding, it is possible to press the molding material 31 in a state in which occurrence of deviation between the axes of the first mold 10 and the second mold 20 is suppressed and open the molds and take out the molded body 30 after performing cooling. Therefore, for example, even when sliding wear occurs in the body mold 1, it is possible to continuously mass-produce a press-molded product having extremely small optical axis deviation.

### Fourth Embodiment

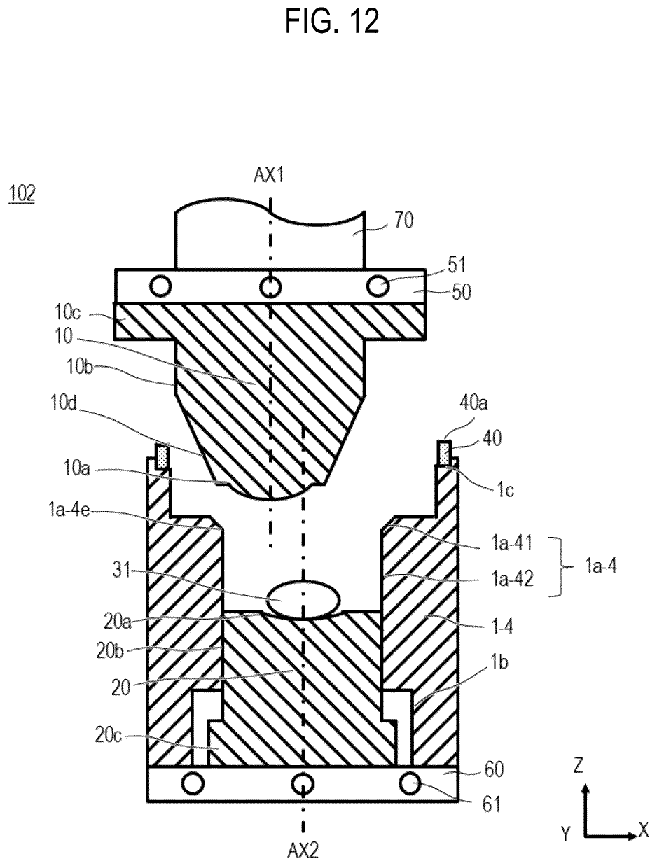

A fourth embodiment is described with reference to FIG. 12. FIG. 12 is a schematic sectional view illustrating a state in which the first mold 10 is opened in a molding apparatus 102 according to the fourth embodiment. Note that, in the present embodiment, the same matters as the matters in the first embodiment are denoted by the same reference numerals and signs and description of the matters is simplified or omitted.

In the first embodiment, the convex section 1a of the body mold 1 has the cylindrical shape centering on the center axis AX2. In contrast, the present embodiment is different in the shape of a convex section 1a-4 of a body mold 1-4. Specifically, the convex section 1a-4 includes a taper surface 1a-41 and a cylinder surface 1a-42 centering on the center axis AX2. The taper surface 1a-41 is further inclined to the center axis AX2 side at a position more distant from the first axis adjustment section 10d of the first mold 10 in the Z direction and is configured such that an angle of the inclination is larger than an inclination angle of the first axis adjustment section 10d.

In the present embodiment, the first mold 10 is moved in the Z minus direction from the state illustrated in FIG. 12. Accordingly, the first axis adjustment section 10d of the first mold 10 comes into contact with a corner section 1a-4e formed by the taper surface 1a-41 and the cylinder surface 1a-42 of the body mold 1-4. When the first mold 10 is further moved in the Z minus direction, stress in the X plus direction is generated in the first mold 10 and stress in the X minus direction is generated in the body mold 1-4. One of the first mold 10 and the body mold 1-4 moves such that the center axis AX1 of the first mold 10 and the center axis AX2 of the convex section 1a-4 are brought close to each other. That is, by providing the taper surface 1a-41, the body mold 1-4 can be fit with the first mold 10 even if the center axis AX1 and the center axis AX2 are further separated than in the first embodiment in the mold opened state.

When the first mold 10 is further moved in the Z minus direction, the first mold 10 and the corner section 1a-4e come into a state of being in contact with the entire region of an annular surface including a circle parallel to the XY plane and the center axis AX1 of the first mold 10 and the center axis AX2 of the convex section 1a-4 of the body mold 1-4 substantially coincide. Thereafter, when the first mold 10 is moved in the Z minus direction, the corner section 1a-4e elastically deforms. Therefore, when pressing of the molding material 31 is completed, the center axis AX1 of the first mold 10, the center axis AX2 of the convex section 1a-4 of the body mold 1-4, and the center axis of the second mold 20 are substantially coaxial.

In the present embodiment as well, when molding is repeated many times, sliding wear of the corner section 1a-4e progresses and a sliding wear section is formed. Even in such a state, as in the first embodiment, a contact section with the first axis adjustment section 10d has a contact surface smaller than a contact surface of the sliding wear section at the corner section 1a-4e of a portion facing the sliding wear section. Thus, an elastic deformation amount of the portion increases. As a result, since one of the first mold 10 and the body mold 1-4 moves such that the center axis AX1 of the first mold 10 and the center axis AX2 of the convex section 1a-4 of the body mold 1-4 are brought close to each other, deviation between the axes is suppressed. For this reason, compared with the schemes of the related art described in Japanese Patent Laid-Open No. 2011-126758 and Patent Publication No. H04-55981, it is possible to substantially reduce possibility of occurrence of deviation between the axes even when an optical element is continuously molded and mass-produced.

In the present embodiment as well, the first mold 10 is moved in the first (Z minus) direction to come close to the second mold 20 held by the body mold 1-4. In that case, one of the first mold 10 and the body mold 1-4 moves in a direction intersecting the first direction and moves in a direction in which the center axis of the first mold 10 and the center axis of the body mold 1-4 are brought close to each other. For example, it could occur that sliding wear occurs in a part of the body mold 1-4 due to continuous molding and, as a result, the center axis AX1 of the first mold 10 is displaced with respect to the center axis AX2 of the convex section 1a-4 of the body mold 1-4. According to the present embodiment, by using elastic deformation of the corner section 1a-4e that occurs with applied pressure smaller than applied pressure at the time of press molding, in the mold clamped state, the positions of the first mold 10 and the body mold 1-4 are automatically adjusted such that the center axis AX1 and the center axis AX2 are brought close to each other. For this reason, even at the time of the continuous molding, it is possible to press the molding material 31 in a state in which occurrence of deviation between the axes of the first mold 10 and the second mold 20 is suppressed and open the molds and take out the molded body 30 after performing cooling. Therefore, for example, even when sliding wear occurs in the body mold 1, it is possible to continuously mass-produce a press-molded product having extremely small optical axis deviation.

### Fifth Embodiment

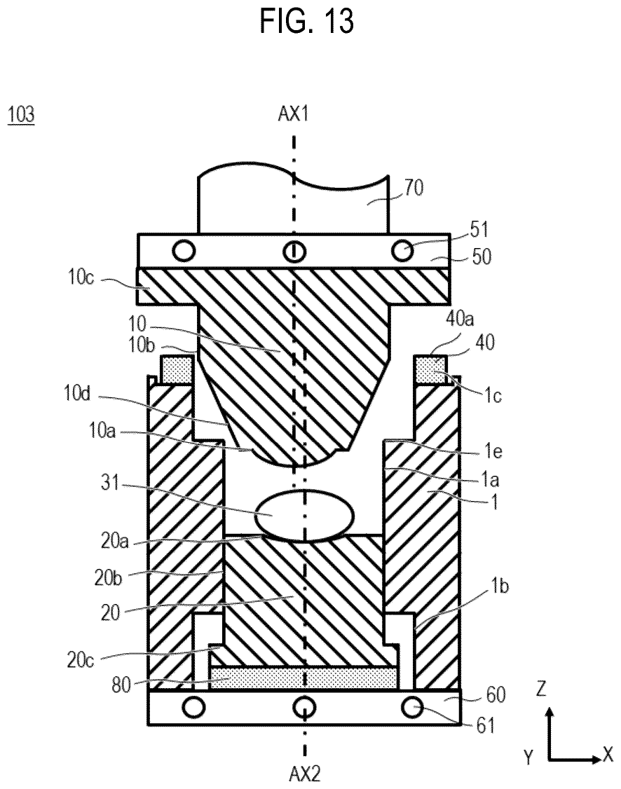

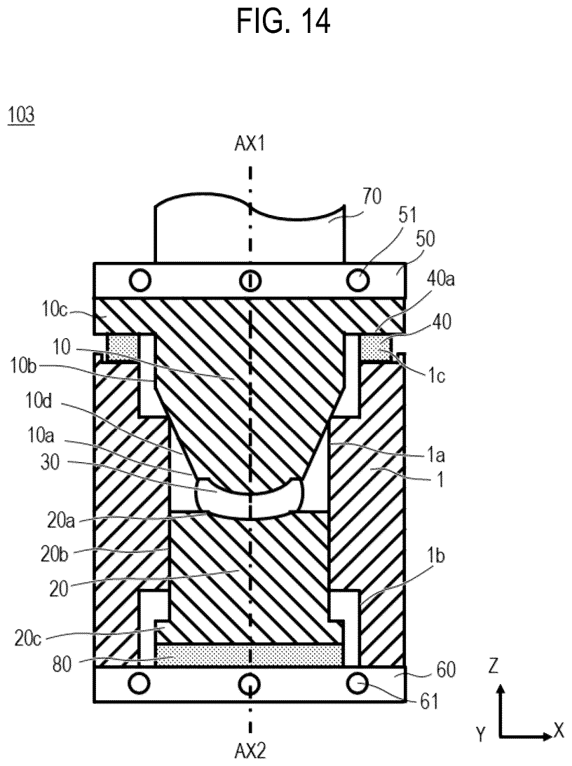

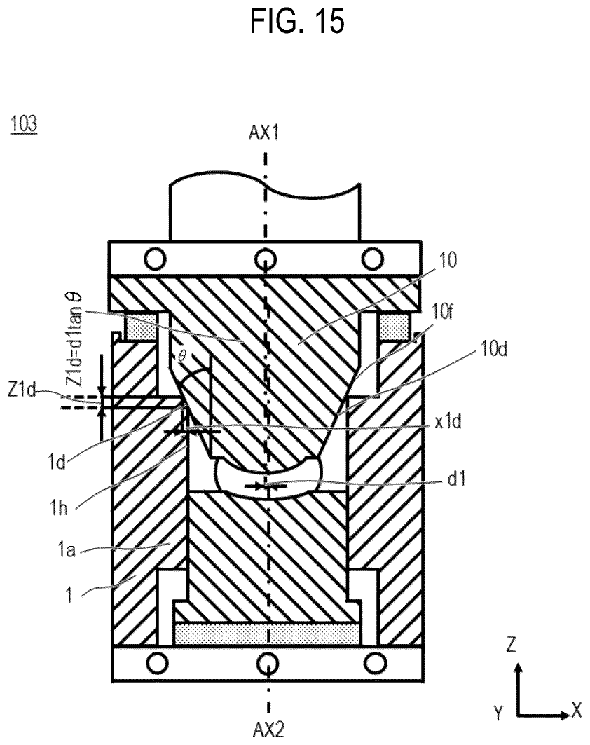

A fifth embodiment is described with reference to FIGS. 13, 14, 15, 16, 17, 18, 19, 20 and 21. FIG. 13 is a schematic sectional view illustrating a state in which a molding apparatus 103 according to the present embodiment opens the first mold 10 before performing a press operation. FIG. 14 is a schematic sectional view illustrating a state in which the molding apparatus 103 closes the first mold 10 in the press operation. FIG. 15 is a schematic sectional view illustrating a correction method in the case in which molding has been repeated many times and sliding wear of the corner section 1e has progressed and deviation between axes has occurred.

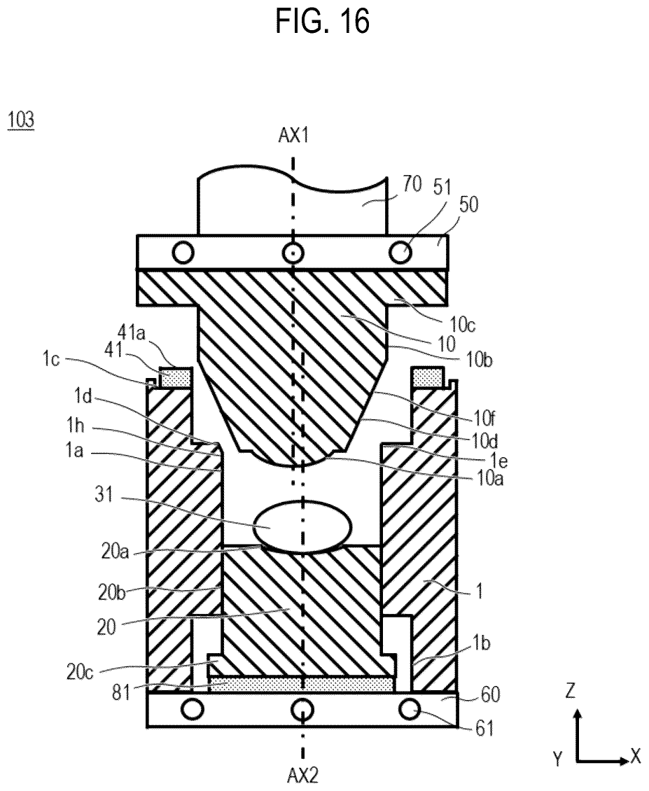

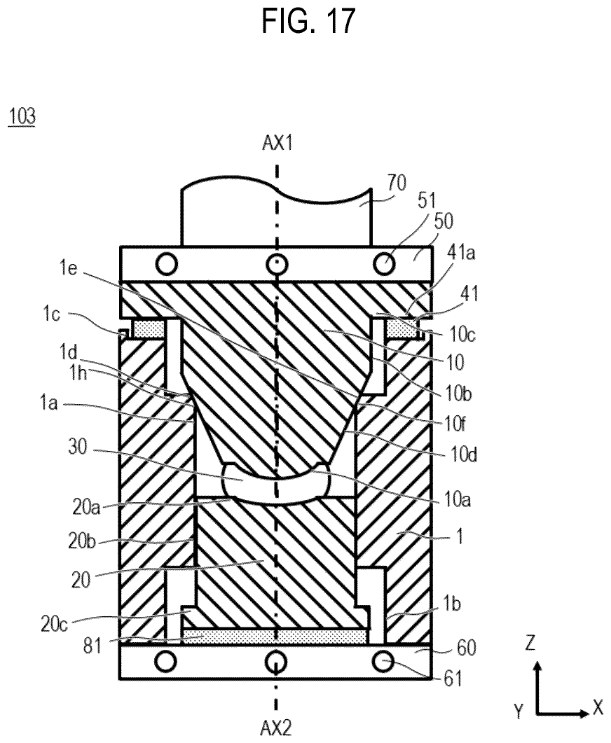

FIG. 16 is a schematic sectional view illustrating a state in which the molding has been repeated many times and the sliding wear of the corner section 1e has progressed and a state in which the first spacer 40 and the second spacer 80 have been changed from those before correction and the first mold 10 has been opened before a press operation is performed in the molding apparatus 103. FIG. 17 is a schematic sectional view illustrating the state in which the molding has been repeated many times and the sliding wear of the corner section 1e has progressed and a state in which the first spacer 40 and the second spacer 80 have been changed from those before correction and the first mold 10 has been closed in the press operation in the molding apparatus 103.

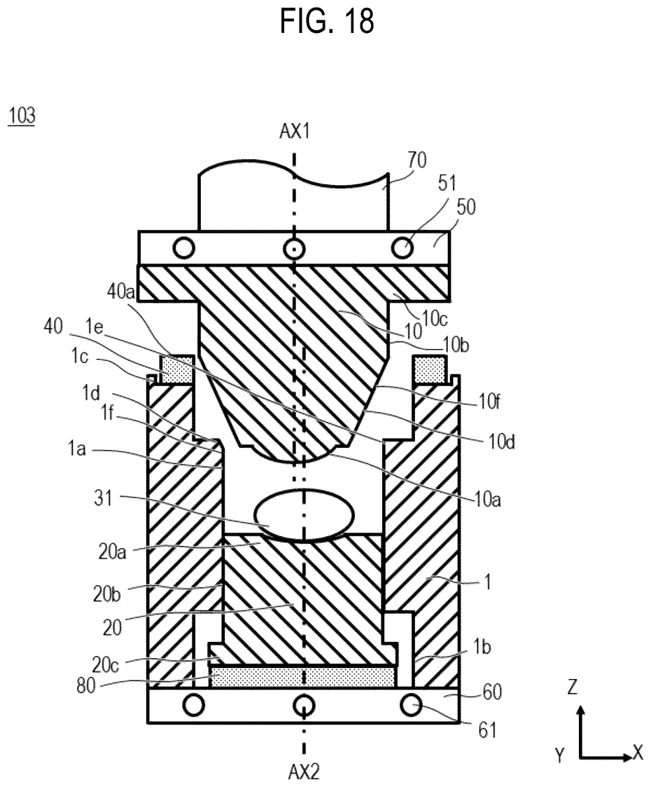

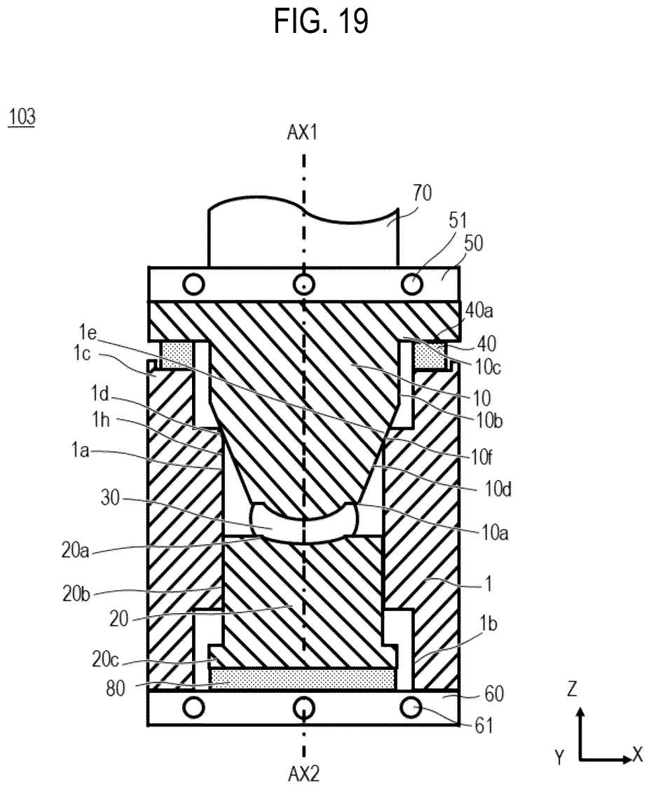

FIG. 18 is a schematic sectional view illustrating the state in which the molding has been repeated many times and the sliding wear of the corner section 1e has progressed and a state in which heating has been performed more than before correction and then the first mold 10 has been opened before the press operation is performed in the molding apparatus 103. FIG. 19 is a schematic sectional view illustrating the state in which the molding has been repeated many times and the sliding wear has progressed and a state in which heating has been performed more than before correction and then the first mold 10 has been closed in the press operation in the molding apparatus 103.

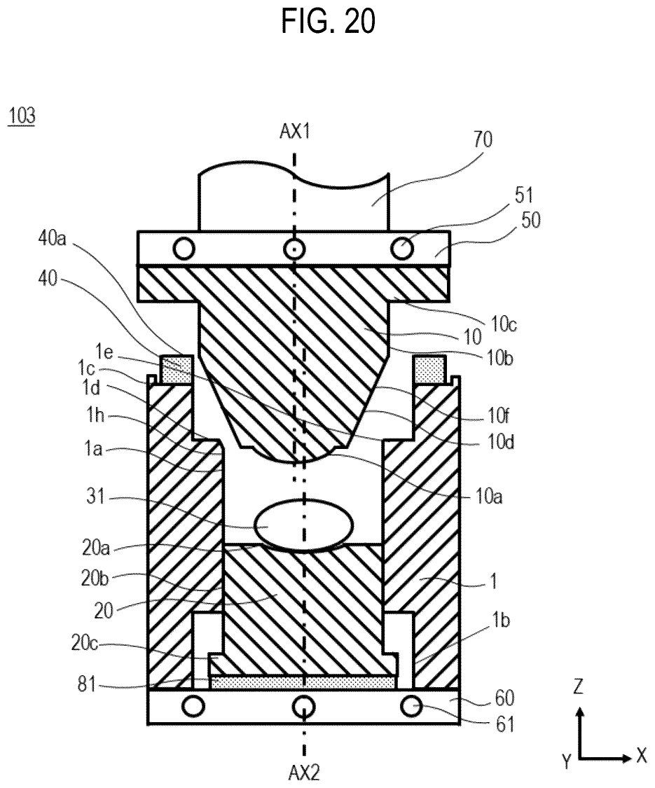

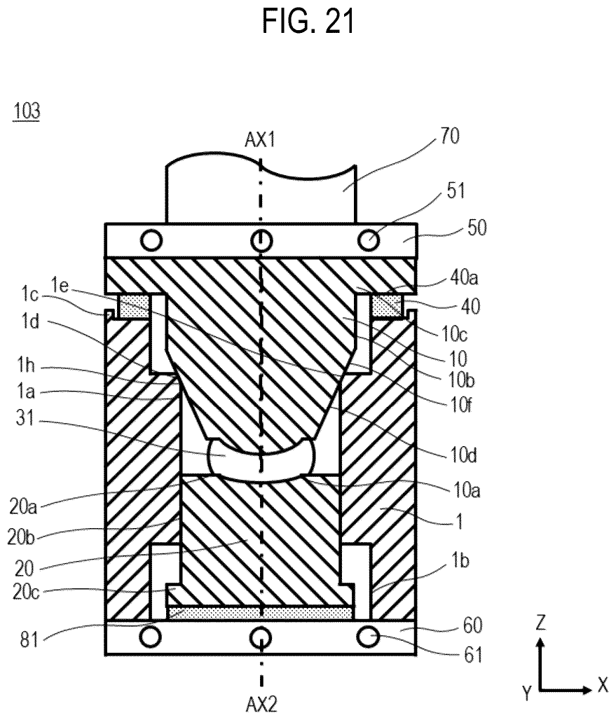

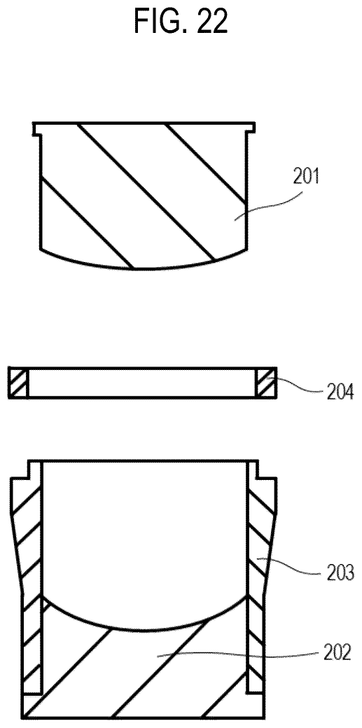

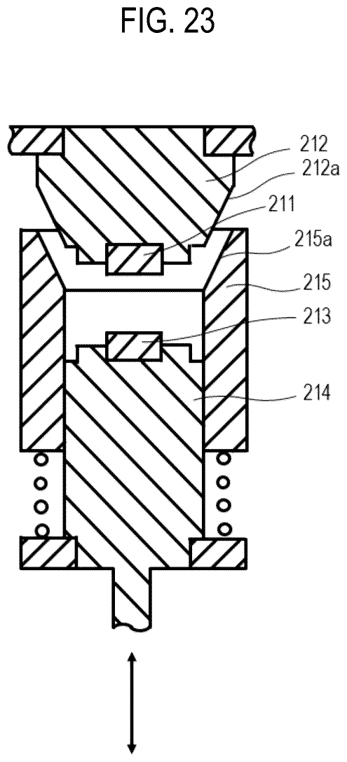

FIG. 20 is a schematic sectional view illustrating the state in which the molding has been repeated many times and the sliding wear of the corner section 1e has progressed and a state in which the second spacer 80 has been changed from that before correction and then a press load has been increased and the first mold 10 has been opened before the press operation is performed in the molding apparatus 103. FIG. 21 is a schematic sectional view illustrating the state in which the molding has been repeated many times and the sliding wear of the corner section 1e has progressed and a state in which the second spacer 80 has been changed from that before correction and then the press load has been increased and the press operation has been performed and the first mold 10 has been closed in the molding apparatus 103.

The molding apparatus 103 according to the fifth embodiment is described below with reference to these drawings. Note that, in the following description, in the present embodiment, the same components as the components in the first embodiment are denoted by the same reference numerals and signs and description of the components is simplified or omitted here.

In the present embodiment, the molding apparatus 103 is different from the molding apparatus 100 described in the first embodiment in that, in addition to the components in the first embodiment, the second spacer 80 that comes into contact with the Z minus direction end portion (the lower end portion) of the second mold 20 is provided.

In the present embodiment, when the first mold 10 is moved in the Z minus direction from the mold opened state illustrated in FIG. 13 toward the mold clamped state illustrated in FIG. 14, the first axis adjustment section 10d of the first mold 10 comes into contact with the corner section 1e of the body mold 1. When the first mold 10 is further moved in the Z minus direction, stress in the X plus direction is generated in the first mold 10, stress in the X minus direction is generated in the body mold 1, and one of the first mold 10 and the body mold 1 moves such that the center axis AX1 of the first mold 10 and the center axis AX2 of the convex section 1a of the body mold 1 are brought close to each other. Note that, the second spacer 80 is used in the present embodiment. Appropriate thickness of the molded body 30 can be obtained by setting thickness te of the second spacer 80 to a value calculated by the following Expression 2. All of these thicknesses are thicknesses specified at the center axis directions.

$$te = ( tc + td ) - ( ta + tb + tf ) \qquad ( Expression 2 )$$

Here, ta is thickness in the center axis AX1 direction of the first mold 10, tb is thickness of the second mold 20 in the center axis AX2 direction of the body mold 1, tc is thickness in the center axis AX2 direction of the body mold 1, td is thickness in the first direction of the first spacer 40, and tf is thickness of the molded body 30 in the first direction.

When the first mold 10 is further moved in the Z minus direction, the first mold 10 and the body mold 1 come into contact with the entire region of an annular surface including a circle parallel to the XY plane and the center axis AX1 of the first mold 10 and the center axis AX2 of the convex section 1a of the body mold 1 substantially coincide. Then, when the first mold 10 is moved in the Z minus direction, while elastically deforming the corner section 1e, the brim section 10c of the first mold 10 comes into contact with and elastically deforms the abutment surface 40a of the first spacer 40 and the first mold 10 reaches the mold clamped state illustrated in FIG. 14. Therefore, when pressing of the molding material 31 is completed, the center axis AX1 of the first mold 10, the center axis AX2 of the convex section 1a of the body mold 1, and the center axis of the second mold 20 are substantially coaxial.

In the present embodiment as well, when the molding is repeated many times, the sliding wear of the corner section 1e progresses and a sliding wear section is formed. Even in such a state, as in the first embodiment, at the corner section 1e of a portion facing the sliding wear section, a contact section with the first axis adjustment section 10d has a contact surface smaller than a contact surface of the sliding wear section. Thus, an elastic deformation amount of the portion increases. As a result, since one of the first mold 10 and the body mold 1 moves such that the center axis AX1 of the first mold 10 and the center axis AX2 of the convex section 1a of the body mold 1 are brought close to each other, deviation between the axes is suppressed.

Further, as illustrated in FIG. 15, even when the molding has been repeated, the sliding wear of the convex section 1a progresses, the sliding wear section 1d is formed, and optical axis deviation has occurred by d1, correction is possible in the present embodiment. When the optical axis deviation occurs by d1, a distance x1d in the X direction of the sliding wear section 1d is also d1. For that reason, when an inclination angle of the first axis adjustment section 10d is θ, a distance z1d in the Z direction of the sliding wear section 1d is calculated by the following Expression 3.

$$z 1 d = d 1 tan θ \qquad ( Expression 3 )$$

In such a case, for example, the thickness in the Z direction of the first spacer 40 is corrected and the position of the first mold 10 at the time of mold clamping is moved by d1tanθ in the Z minus direction with respect to the corner section 1e of the body mold 1. Accordingly, it is possible to bring a non-sliding wear section 10f of the first mold 10 and a non-sliding wear section 1h of the body mold 1 into contact with the entire region of an annular surface including a circle parallel to the XY plane and it is possible to suppress deviation between the axes. For this reason, compared with the schemes of the related art described in Japanese Patent Laid-Open No. 2011-126758 and Japanese Patent Publication No. H04-55981, it is possible to substantially reduce occurrence of deviation between the axes even when an optical element is continuously molded and mass-produced.

When the first mold 10 is moved in the Z minus direction with respect to the corner section 1e of the body mold 1, the distance in the Z direction between the molding surface 10a of the first mold 10 and the molding surface 20a of the second mold 20 decreases and the thickness of the molded body 30 decreases. In such a case, it is desirable to add the second spacer 80 by the distance or correct the thickness in the Z direction, move the second mold 20 in the Z minus direction, and maintain the thickness of the molded body 30 before and after the correction.

Note that, in order to move the first mold 10 in the Z minus direction with respect to the corner section 1e of the body mold 1, it is desirable that the first spacer 40 is detachably attachable and can be changed to any thickness at the time of the mold opened state illustrated in FIG. 16. In order to move the second mold 20 in the Z minus direction, it is desirable that the second spacer 80 is detachably attachable and can be changed to any thickness (for example, a second spacer 81 having different thickness illustrated in FIG. 17) at the time of the mold opened state illustrated in FIG. 16. Accordingly, it is possible to suppress deviation between the axes at the time of the mold clamped state illustrated in FIG. 17.

Alternatively, it is assumed that the molds are heated and clamped from the mold opened state illustrated in FIG. 18. In such a case, in order to move the first mold 10 in the Z minus direction with respect to the corner section 1e of the body mold 1, it is desirable that the first spacer 40 has a smaller coefficient of thermal expansion than at least one of the first mold 10 and the body mold 1. Next, a preferable coefficient of thermal expansion αe of the second spacer 80 is described. A coefficient of thermal expansion of the first mold 10 is represented as αe, the thickness of the first mold 10 is represented as ta, a coefficient of thermal expansion of the second mold 20 is represented as αb, the thickness of the second mold 20 is represented as tb, a coefficient of thermal expansion of the body mold 1 is represented as αc, the thickness of the body mold 1 is represented as tc, a coefficient of thermal expansion of the first spacer 40 is represented as αd, the thickness of the first spacer 40 is represented as td, and a coefficient of thermal expansion of the second spacer 80 is represented as αe and the thickness of the second spacer 80 is represented as te. At this time, when heated by temperature αT, a change amount z20a of the distance in the Z direction between the molding surface 10a of the first mold 10 and the molding surface 20a of the second mold 20 is calculated by the following Expression 4.

$$z 20 a = ( α c \times tc \times Δ T + α d \times td \times Δ T ) - ( α a \times ta \times Δ T + α b \times tb \times Δ T + α e \times te \times Δ T ) \qquad ( Expression 4 )$$

Here, in order to maintain the thickness of the molded body 30 before and after the heating, it is necessary to satisfy z20a=0 in Expression 3. Therefore, it is desirable that the coefficient of thermal expansion αe of the second spacer 80 satisfies the following Expression 5.

$$α e = \{ ( α c \times tc + α d \times td ) - ( α a \times ta + α b \times tb ) \} / te \qquad ( Expression 5 )$$

By setting the coefficients of thermal expansion and the thicknesses of the molds, the body mold, and the spacers as described above, it is possible to suppress deviation between the axes at the time of the mold clamped state illustrated in FIG. 19.

Alternatively, when the molds are clamped and pressurized from the mold opened state illustrated in FIG. 20, in order to move the first mold 10 in the Z minus direction with respect to the corner section 1e of the body mold 1, it is desirable that a modulus of longitudinal elasticity of the first spacer 40 is smaller than a modulus of longitudinal elasticity of the body mold 1. In order to move the second mold 20 in the Z minus direction, it is desirable that the second spacer 80 is detachably attachable and can be changed to any thickness (for example, the second spacer 81 having different thickness in FIG. 20) at the time of the mold opened state illustrated in FIG. 20. Accordingly, it is possible to suppress deviation between the axes at the time of the mold clamped state illustrated in FIG. 21.

In the present embodiment as well, the first mold 10 is moved in the first (Z minus) direction to come close to the second mold 20 held by the body mold 1. In that case, one of the first mold 10 and the body mold 1 moves in the direction intersecting the first direction and moves in a direction in which the center axis of the first mold 10 and the center axis of the body mold 1 are brought close to each other. For example, sliding wear occurs in a part of the body mold 1 due to continuous molding and the center axis AX1 of the first mold 10 is displaced with respect to the center axis AX2 of the convex section 1a of the body mold 1. According to the present embodiment, by using elastic deformation of the corner section 1e that occurs with applied pressure smaller than applied pressure at the time of press molding, in the mold clamped state, the positions of the first mold 10 and the body mold 1 are automatically adjusted such that the center axis AX1 and the center axis AX2 are brought close to each other. For this reason, even at the time of continuous molding, after the molding material 31 is pressed in a state in which occurrence of deviation between the axes of the first mold 10 and the second mold 20 is suppressed and cooling is performed, the molds are opened and the molded body 30 can be taken out. Therefore, for example, even when sliding wear has occurred in the body mold 1, it is possible to continuously mass-produce a press-molded product having extremely small optical axis deviation.

### Example 5-1

Here, concerning the fifth embodiment, a specific implementation mode of the fifth embodiment is described below as an example 5-1. In the example 5-1, optical glass serving as a molding material is press-molded to manufacture an optical element serving as a molded body using the molding apparatus 103 described with reference to FIGS. 13, 14, 15, 16 and 17. A press molding process is performed in an N₂ gas atmosphere in order to prevent oxidation of the molds and the apparatus.

In the example 5-1, a series of operations including the mold opening illustrated in FIG. 13 and the mold clamping illustrated in FIG. 14 was repeated to continuously mass-produce a press-molded product by the same molding method as the molding method of the example 1 described with reference to FIG. 8. In the press molding process, when the number of times of molding exceeds ten thousand times, sliding wear of the corner section 1e progresses from a molding initial stage and optical axis deviation increases. For this reason, in this example, correction processing for the molding apparatus is performed to execute the following molding process.

In a correction process, first, in a mold opened state in which the brim section 10c of the first mold 10 is separated from the first spacer 40 and before heating is performed, the detachable first and second spacers 40 and 80 are detached. As illustrated in FIG. 15, a distance z1d (a correction value dz) in the Z direction of the sliding wear section 1d is calculated by Expression 2 from an optical axis deviation amount and an inclination angle of the first axis adjustment section 10d. Further, a first space 41 (see FIG. 16) obtained by reducing the first spacer 40 in thickness by the correction value dz is attached such that the first mold 10 can be moved in the Z minus direction with respect to the convex section 1a of the body mold 1 by the correction value dz in the mold clamped state. In order to move the second mold 20 in the Z minus direction by the correction value dz, a second spacer 81 obtained by reducing the second spacer 80 in thickness by the correction value dz is attached.

After the replacement of the spacers, the first mold 10, the second mold 20, the body mold 1, a first spacer 41 and the second spacer 81 are heated to a predetermined temperature using the heater 51 and the heater 61 and these components are retained at the predetermined temperature. Subsequently, an optical glass material serving as the molding material 31 is placed with high position accuracy at the center of the molding surface 20a of the second mold 20 by a not-illustrated hand. Thereafter, the first mold 10, the second mold 20, the body mold 1, the first spacer 41 and the second spacer 81 are heated to a press temperature by the heater 51 and the heater 61 and these components are retained at the temperature.

Thereafter, the driving source 70 moves the first mold 10 and the first mold holding member 50 in the Z minus direction. When the movement is continued, the first axis adjustment section 10d of the first mold 10 comes into contact with the corner section 1e of the body mold 1. When the first mold 10 is further moved in the Z minus direction from this state, the corner section 1e starts elastic deformation. Substantially simultaneously, stress in the X plus direction is generated in the first mold 10 and stress in the X minus direction is generated in the body mold 1. Automatic position adjustment for each of the first mold 10 and the body mold 1 for moving one of the first mold 10 and the body mold 1 is performed by the stresses such that the center axis AX1 of the first mold 10 and the center axis AX2 of the convex section 1a of the body mold 1 are brought close to each other.

When the first mold 10 is further moved in the Z minus direction, the non-sliding wear section 10f of the first mold 10 and the non-sliding wear section 1h of the body mold 1 come into a state of being in contact along the circle parallel to the XY plane. Accordingly, deviation between the center axis AX1 of the first mold 10 and the center axis AX2 of the convex section 1a of the body mold 1 is suppressed by the action of the stresses described above. Thereafter, when the first mold 10 is moved in the Z minus direction, the corner section 1e further elastically deforms.

When the first mold 10 is further moved in the Z minus direction, the brim section 10c of the first mold 10 comes into contact with an abutment surface 41a of the first spacer 41, the first spacer 41 elastically deforms according to a press load, and the first mold 10 reaches the mold clamped state illustrated in FIG. 17. When the press load is applied while the first mold 10 being moved in the Z minus direction, the molding material 31 is sandwiched between the molding surface 10a of the first mold 10 and the molding surface 20a of the second mold 20 and pressed and the shape of the optical element is transferred onto the molding material 31.

When the molding material 31 is pressed to predetermined thickness and the press molding ends, a press pressure is maintained or the press pressure is switched to lower pressure and the molding method shifts to a cooling step. As described above, the first mold 10, the second mold 20, the body mold 1, the first spacer 41 and the second spacer 81 are cooled by the N₂ gas supplied through the not-illustrated N₂ introduction pipe. A flow rate of the N₂ gas is controlled by, for example, supplying the N₂ gas through a mass-flow controller. The flow rate is controlled such that the cooling is performed at an appropriate cooling rate.

Here, the press pressure is maintained or switched to high pressure in order to prevent the optical element, which is the molded body, from contracting and being separated from the molding surface 10a of the first mold 10 and the molding surface 20a of the second mold 20 while the molds are opened and the molded body 30 is cooled to temperature at which the molded body 30 can be taken out. At a point in time when the temperature of the molded body 30 has reached a predetermined temperature equal to or lower than the glass transition point, the pressure applied to the first mold 10 by the driving source 70 is released and cooling is further performed as necessary. At a point in time when the temperature of the molded body 30 has reached a predetermined temperature at which the molded body 30 can be taken out, the first mold 10 is moved in the Z plus direction by the driving source 70 and mold opening is performed. The molded body 30 is taken out from the molding surface 20a of the second mold 20 by a not-illustrated hand to end the molding. An optical element, which is a molded product, having high shape accuracy is mass-produced by repeating the series of operations described above.

### Example 5-2

Another specific implementation mode of the fifth embodiment is described below as an example 5-2. In the example 5-2, optical glass serving as a molding material is press-molded using the molding apparatus described with reference to FIGS. 13, 14, 18 and 19 to manufacture an optical element serving as a molded body. A press molding process is performed in an N₂ gas atmosphere in order to prevent oxidation of the molds and the apparatus.

In the example 5-2, a series of operations including the mold opening illustrated in FIG. 13 and the mold clamping illustrated in FIG. 14 was repeated to continuously mass-produce a press-molded product by the same molding method as the molding method of the example 1. In the press molding process, when the number of times of molding exceeds ten thousand times, sliding wear of the corner section 1e progresses from a molding initial stage and optical axis deviation increases. For this reason, in this example, correction processing for the molding apparatus is performed to execute the following molding process. The correction processing is performed by the replacement of the spacers in the example 5-1. However, in this example, correction during the molding process is enabled by using a difference in thermal expansion of the respective components in the molding apparatus.

In the molding process in this example, first, as illustrated in FIG. 16, the first mold 10 is set in a mold opened state in which the brim section 10c of the first mold 10 is separated from the first spacer 40. The first mold 10, the second mold 20, the body mold 1, the first spacer 40 and the second spacer 80 are heated to predetermined temperature using the heater 51 and the heater 61 and these components are retained at the predetermined temperature. Subsequently, an optical glass material is placed with high position accuracy as the molding material 31 at the center of the molding surface 20a of the second mold 20 by a not-illustrated hand. Thereafter, the first mold 10, the second mold 20, the body mold 1, the first spacer 40 and the second spacer 80 are heated to a press temperature by the heater 51 and the heater 61.

Here, the distance z1d (the correction value dz) in the Z direction of the sliding wear section 1d is calculated by Expression 2 in advance from an optical axis deviation amount and an inclination angle of the first axis adjustment section 10d. In this example, here, in the mold clamped state, the first mold 10 is heated and thermally expanded to move in the Z minus direction by the correction value dz with respect to the corner section 1e of the body mold 1.

Here, a coefficient of thermal expansion of the first mold 10 is represented as αa, a coefficient of thermal expansion of the body mold 1 is represented as αc, and a coefficient of thermal expansion of the first spacer 40 is represented as αd. The distance from a contact surface of the first mold 10 with the first spacer 40 to the Z minus direction end portion (the lower end portion) of the non-sliding wear section 10f is represented as l1. The distance from a contact surface of the body mold 1 with the first spacer 40 to the Z plus direction end portion (the upper end portion) of the non-sliding wear section 1h is represented as l2 and the thickness of the first spacer 40 is represented as l3. A temperature rise from temperature before correction is represented as ΔT. In this case, in order to move the first mold 10 in the Z minus direction by the correction value dz or more with respect to the convex section 1a of the body mold 1, it is necessary to satisfy the following Expression 6.

$$dz \leq α a \times l 1 \times Δ T - ( α c \times l 2 \times Δ T + α d \times l 3 \times Δ T ) \qquad ( Expression 6 )$$

Therefore, the molds are further heated by ΔT or more to raise the temperature to satisfy the following Expression 7.

$$Δ T \geq dz / ( α a \times l 1 - α c \times l 2 + α d \times l 3 ) \qquad ( Expression 7 )$$

After the first mold 10 is heated and thermally expanded according to the above conditions, the first mold 10 and the first mold holding member 50 are moved in the Z minus direction by the driving source 70. When the movement is continued, the first axis adjustment section 10d of the first mold 10 comes into contact with the corner section 1e of the body mold 1. When the first mold 10 is further moved in the Z minus direction from this state, the corner section 1e starts elastic deformation. Substantially simultaneously, stress in the X plus direction is generated in the first mold 10 and stress in the X minus direction is generated in the body mold 1. Automatic position adjustment for each of the first mold 10 and the body mold 1 for moving one of the first mold 10 and the body mold 1 is performed by the stresses such that the center axis AX1 of the first mold 10 and the center axis AX2 of the convex section 1a of the body mold 1 are brought close to each other.

When the first mold 10 is further moved in the Z minus direction, the non-sliding wear section 10f of the first mold 10 and the non-sliding wear section 1h of the body mold 1 come into a state of being in contact along a circle parallel to the XY plane. Accordingly, deviation between the center axis AX1 of the first mold 10 and the center axis AX2 of the convex section 1a of the body mold 1 is suppressed by the action of the stresses described above. Thereafter, when the first mold 10 is moved in the Z minus direction, the corner section 1e further elastically deforms.

When the first mold 10 is further moved in the Z minus direction, the brim section 10c of the first mold 10 comes into contact with the abutment surface 40a of the first spacer 40, the first spacer 40 elastically deforms according to a press load, and the first mold 10 reaches the mold clamped state illustrated in FIG. 19. When the press load is applied while the first mold 10 being moved in the Z minus direction, the molding material 31 is sandwiched between the molding surface 10a of the first mold 10 and the molding surface 20a of the second mold 20 and pressed and the shape of the optical element is transferred onto the molding material 31.

When the molding material 31 is pressed to predetermined thickness and the press molding ends, a press pressure is maintained or the press pressure is switched to lower pressure and the molding method shifts to a cooling step. As described above, the first mold 10, the second mold 20, the body mold 1, the first spacer 40 and the second spacer 80 are cooled by the N₂ gas supplied through the not-illustrated N₂ introduction pipe. A flow rate of the N₂ gas is controlled by, for example, supplying the N₂ gas through a mass-flow controller. The flow rate is controlled such that the cooling is performed at an appropriate cooling rate.

Here, the press pressure is maintained or switched to high pressure in order to prevent the optical element, which is the molded body, from contracting and being separated from the molding surface 10a of the first mold 10 and the molding surface 20a of the second mold 20 while the molds are opened and the molded body 30 is cooled to temperature at which the molded body 30 can be taken out. At a point in time when the temperature of the molded body 30 has reached a predetermined temperature equal to or lower than the glass transition point, the pressure applied to the first mold 10 by the driving source 70 is released and cooling is further performed as necessary. At a point in time when the temperature of the molded body 30 has reached a predetermined temperature at which the molded body 30 can be taken out, the first mold 10 is moved in the Z plus direction by the driving source 70 and mold opening is performed. The molded body 30 is taken out from the molding surface 20a of the second mold 20 by a not-illustrated hand to end the molding. An optical element, which is a molded product, having high shape accuracy is mass-produced by repeating the series of operations described above.

### Example 5-3

Still another specific implementation mode of the fifth embodiment is described below as an example 5-3. In the example 5-3, optical glass serving as a molding material is press-molded using the molding apparatus described with reference to FIGS. 13, 14, 20 and 21 to manufacture an optical element serving as a molded body. A press molding process is performed in an N₂ gas atmosphere in order to prevent oxidation of the molds and the apparatus.

In the example 5-3, a series of operations including the mold opening illustrated in FIG. 13 and the mold clamping illustrated in FIG. 14 was repeated to continuously mass-produce a press-molded product by the same molding method as the molding method of the example 1. In the press molding process, when the number of times of molding exceeds ten thousand times, sliding wear of the corner section 1e progresses from a molding initial stage and optical axis deviation increases. For this reason, in this example, correction processing for the molding apparatus is performed to execute the following molding processing. In the example 5-1, the correction processing is performed by the replacement of the spacers and, in the example 5-3, the correction processing is performed according to the difference in the thermal expansion amount of the respective components. In contrast, in this example, correction in a molding process is enabled by using the replacement of the spacers and a change in a press load focusing on a difference in a modulus of longitudinal elasticity of the respective components.

In the molding process in this example, first, the detachable second spacer 80 is detached in a mold opened state in which the brim section 10c of the first mold 10 is separated from the first spacer 40 and before heating is performed. As illustrated in FIG. 20, the distance z1d (the correction value dz) in the Z direction of the sliding wear section 1d is calculated by Expression 2 from an optical axis deviation amount and an inclination angle of the first axis adjustment section 10d. Further, in order to move the second mold 20 in the Z minus direction by the correction value dz, the second spacer 81 obtained by reducing the second spacer 80 in thickness by the correction value dz is attached.

After the replacement of the spacers, the first mold 10, the second mold 20, the body mold 1, the first spacer 40 and the second spacer 81 are heated to a predetermined temperature using the heater 51 and the heater 61 and these components are retained at the predetermined temperature. Subsequently, an optical glass material serving as the molding material 31 is placed with high position accuracy at the center of the molding surface 20a of the second mold 20 by a not-illustrated hand. Thereafter, the first mold 10, the second mold 20, the body mold 1, the first spacer 40 and the second spacer 81 are heated to a press temperature by the heater 51 and the heater 61 and these components are retained at the temperature.

Thereafter, the driving source 70 moves the first mold 10 and the first mold holding member 50 in the Z minus direction. When the movement is continued, the first axis adjustment section 10d of the first mold 10 comes into contact with the corner section 1e of the body mold 1. When the first mold 10 is further moved in the Z minus direction from this state, the corner section 1e starts elastic deformation. Substantially simultaneously, stress in the X plus direction is generated in the first mold 10 and stress in the X minus direction is generated in the body mold 1. Automatic position adjustment for each of the first mold 10 and the body mold 1 for moving one of the first mold 10 and the body mold 1 is performed by the stresses such that the center axis AX1 of the first mold 10 and the center axis AX2 of the convex section 1a of the body mold 1 are brought close to each other.

When the first mold 10 is further moved in the Z minus direction, the brim section 10c of the first mold 10 comes into contact with the abutment surface 40a of the first spacer 40 and the first spacer 40 and the body mold 1 elastically deform due to a press load. Here, a modulus of longitudinal elasticity of the body mold 1 is represented as Ec and a modulus of longitudinal elasticity of the first spacer 40 is represented as Ed. A maximum sectional area in the XY plane of the body mold 1 is represented as Sc and a maximum sectional area in the XY plane of the first spacer 40 is represented as Sd. The distance from a contact surface of the body mold 1 with the first spacer 40 to the Z plus direction end portion (the upper end portion) of the non-sliding wear section 1h is represented as l2 and the thickness of the first spacer 40 is represented as l3. When a press load further increased from that before correction is represented as ΔF, it is necessary to satisfy the following Expression 8 in order to move the first mold 10 in the Z minus direction by the correction value dz or more with respect to the convex section 1a of the body mold 1.

$$dz \leq Δ F \times l 2 / Sc \times Ec + Δ F \times l 3 / Sd \times Ed \qquad ( Expression 8 )$$

Therefore, the press load is further increased by ΔF or more to satisfy the following Expression 9.

$$Δ F \geq dz / \{ ( l 2 / Sc \times Ec ) + ( l 3 / Sd \times Ed ) \} \qquad ( Expression 9 )$$

By increasing the press load to satisfy the conditions described above, the non-sliding wear section 10f of the first mold 10 and the non-sliding wear section 1h of the body mold 1 can come into a state of being in contact along a circle parallel to the XY plane. As a result, deviation between the axes of the center axis AX1 of the first mold 10 and the center axis AX2 of the convex section 1a of the body mold 1 is suppressed and the first mold 10 reaches a mold clamped state illustrated in FIG. 21. When the press load is applied while the first mold 10 being moved in the Z minus direction, the molding material 31 is sandwiched between the molding surface 10a of the first mold 10 and the molding surface 20a of the second mold 20 and pressed and the shape of the optical element is transferred onto the molding material 31.

When the molding material 31 is pressed to predetermined thickness and the press molding ends, a press pressure is maintained or the press pressure is switched to lower pressure and the molding method shifts to a cooling step. As described above, the first mold 10, the second mold 20, the body mold 1, the first spacer 40 and the second spacer 81 are cooled by the N₂ gas supplied through the not-illustrated N₂ introduction pipe. A flow rate of the N₂ gas is controlled by, for example, supplying the N₂ gas through a mass-flow controller. The flow rate is controlled such that the cooling is performed at an appropriate cooling rate.

Here, the press pressure is maintained or switched to high pressure in order to prevent the optical element, which is the molded body, from contracting and being separated from the molding surface 10a of the first mold 10 and the molding surface 20a of the second mold 20 while the molds are opened and the molded body 30 is cooled to temperature at which the molded body 30 can be taken out. At a point in time when the temperature of the molded body 30 has reached a predetermined temperature equal to or lower than the glass transition point, the pressure applied to the first mold 10 by the driving source 70 is released and cooling is further performed as necessary. At a point in time when the temperature of the molded body 30 has reached a predetermined temperature at which the molded body 30 can be taken out, the first mold 10 is moved in the Z plus direction by the driving source 70 and mold opening is performed. The molded body 30 is taken out from the molding surface 20a of the second mold 20 by a not-illustrated hand to end the molding. An optical element, which is a molded product, having high shape accuracy is mass-produced by repeating the series of operations described above.

As described above, the molding apparatus (100) according to the present disclosure includes the first mold 10, the second mold 20, and the body mold 1 into which the first mold 10 and the second mold 20 are fit and inserted. In the molding apparatus, the body mold 1 includes the corner section 1e on a fitting surface with the first mold 10. The first mold 10 includes the inclined surface (the first axis adjustment section 10d) that comes into contact with the corner section 1e. Note that, in one of the embodiments and the examples described above, a mold housing space in the body mold 1 into which the first mold 10 is fit and inserted is described as being formed in a cylindrical shape. However, a housing space to which the present disclosure is applied is not limited to the cylindrical shape and can be formed in various shapes depending on uses of the molding apparatus, materials of the components, and the like, for example, the shape of a cross section perpendicular to the center axis in the body mold 1 is an ellipse, a polygon, and the like. The inclined surface (10d) provided in the first mold 10 is also not limited to the truncated cone and can be changed to correspond to the shape of the housing space. The inclined surface may have a shape that is formed such that the distance from the center axis decreases toward a direction close to the disposition of the body mold 1, for example, in the first direction, which is the direction in which the first mold 10 moves, and that can come into substantially linear contact when coming into contact with a corner section. Note that “substantially linear contact” includes a case in which, even when the inclined surface comes into partial point contact depending on machining accuracy of the corner section top and the flatness of the inclined surface, a contact section is linear when the corner section top elastically deforms with a load.

In the molding apparatus described above, the first mold 10 is moved in the first direction and the molding material 31 is sandwiched between the first mold 10 and the second mold 20 to mold the molded body 30. In that case, the first mold 10 moves in a state in which the corner section 1e of the body mold 1 and the inclined surface (10d) of the first mold 10 are in contact, whereby the center axis AX1 of the first mold 10 and the center axis (AX2) of the body mold 1 are aligned. A contact section of the corner section 1e of the body mold 1 with the first mold 10 (the inclined surface) viewed from the first direction is provided in one of a circular shape and an arcuate shape.

Note that, in the molding apparatus described above, for example, as exemplified in the third embodiment, at least a part of the corner section 1e may be provided at a position facing the inclined surface (10d) of the first mold 10 in a direction in which the center axis AX2 of the body mold 1 extends. As exemplified in the first embodiment, the corner section 1e can be formed by, in a cross section along the center axis AX2 of the body mold 1, a fitting surface and a surface intersecting the fitting surface at an angle different from the angle of the inclined surface. However, a form of the corner section 1e is not limited to this example and, for example, as exemplified in FIG. 12, may be formed by two surfaces (1a-41 and 1a-42) extending and intersecting the inclined surface (10d) respectively at different angles in the body mold 1.

In the molding apparatus described above, as exemplified in FIG. 7, the corner section 1e of the body mold 1 viewed from the first direction can be provided over the inner circumference of the fitting surface of the body mold 1. However, for example, as exemplified in FIGS. 11A and 11B, the corner section 1e may be partially provided.

The molding apparatus described above further includes the first spacer 40 disposed between the body mold 1 and the first mold 10. The first spacer 40 is provided such that, when the first mold 10 is moved in the first direction and the molding material 31 is sandwiched between the first mold 10 and the second mold 20 to mold the molded body 30, the first mold 10 elastically deforms by applying a predetermined pressing load to the first spacer 40. The first spacer 40 is preferably provided to elastically deform in a range of 0.5 μm or more and 300 μm or less in the first direction. The thickness td in the first direction of the first spacer 40 is preferably satisfies td≤La−Lc. Note that, in the expression, when the inner diameter of the corner section 1e in contact with the inclined surface is Rc, La is the distance, viewed from the first direction, from a position where the outer diameter of the inclined surface of the first mold 10 is Rc to a contact surface with the first spacer 40. Lc is the distance, in the first direction, from a position where the inner diameter of the corner section 1e in contact with the inclined surface of the body mold 1 is Rc to the contact surface with the first spacer 40.

In the molding apparatus described above, the first mold 10 and the body mold 1 can be made of different kinds of materials such that the inclined surface (10d) can smoothly slide with respect to the corner section 1e. Further, the second mold 20 can be made of a material having a larger coefficient of thermal expansion than the body mold 1 such that the gap between the second mold 20 and the body mold 1 can be reduced at the time of molding. Note that, in the embodiments described above, the inclined surface (10d) is formed in the truncated cone shape. The truncated cone shape is suitable because a contact portion is circular at a contact initial stage of being in substantially linear contact with the corner section 1e and suitable sliding can be obtained on all contact surfaces. However, if appropriate sliding can be obtained, the inclined surface may be formed in another shape tapered in the Z minus direction of the first mold 10.

The molding apparatus described above may further include the second spacer 80 disposed at the end portion in the Z minus direction of the second mold 20 in the embodiments described above. In that case, the thickness te of the second spacer 80 preferably satisfies te=(tc+td)−(ta+tb+tf) (Expression 2). Note that, in Expression 2, ta is the thickness in the center axis AX1 direction of the first mold 10, tb is the thickness of the second mold 20 in the center axis AX2 direction of the body mold 1, tc is the thickness in the center axis AX2 direction of the body mold 1, td is the thickness of the first spacer 40 in the first direction, and tf is the thickness of the molded body 30 in the first direction. The first spacers 40 and 41 and the second spacers 80 and 81 can be detachably attachable to the first mold 10 and the second mold 20 and the body mold 1.

Further, the first spacers 40 and 41 should have a smaller coefficient of thermal expansion than at least one of the first mold 10 and the body mold 1 to move the first mold 10 in the Z minus direction with respect to the corner section 1e when the molded body 30 is clamped. The coefficient of thermal expansion αe of the second spacers 80 and 81 preferably satisfies αe={(αc×tc+αd×td)−(αa×ta+αb×tb)}/te (Expression 5). Note that, in Expression 5, a is the coefficient of thermal expansion of the first mold 10, αb is the coefficient of thermal expansion of the second mold 20, αc is the coefficient of thermal expansion of the body mold 1, and αd is the coefficient of thermal expansion of the first spacers 40 and 41. The first spacers 40 and 41 can be made of a material having a smaller modulus of longitudinal elasticity than the body mold 1 to easily move the first mold 10 in the Z minus direction with respect to the corner section 1e. If the modulus of longitudinal elasticity of the first spacers 40 and 41 is small, it is expected that a change in thickness due to a load increases and the movement in the Z minus direction of the corner section 1e is further increased. Because of the same reason, the second spacers 80 and 81 can be detachably attachable to the second mold 20 and the body mold 1 to be changeable to spacers having different thickness.

As described above, the molding apparatus according to the present disclosure is the molding apparatus that press-molds an optical member such as a lens. The first mold 10 includes the inclined surface (10d) and the body mold 1 includes the corner section 1e. The inclined surface (10d) is configured such that, when the first mold 10 is disposed in the molding apparatus, the distance from the center axis decreases toward a direction closer to the body mold 1 in the first direction. The corner section 1e is formed by two surfaces (the inner circumferential surface of the convex section 1a and the Z plus direction end face of the convex section 1a) that extend respectively at different angles and intersect in the body mold 1 with respect to the inclined surface (10d) and is disposed to face the inclined surface (10d) in the first direction. The corner section 1e is configured to come into contact with the inclined surface (10d) when the optical material (the molding material 31) is sandwiched between the first mold 10 and the second mold 20.

In the molding apparatus described above, the corner section 1e is configured such that the top of the corner section 1e comes into contact with the inclined surface (10d) first in the cross section along the first direction when the first mold 10 is moved to come close to the position where the optical material (the molding material 31) is sandwiched. The corner section 1e is capable of elastically deforming with a press load applied to the first mold 10 when the optical material (the molding material 31) is press-molded. The first mold 10 and the body mold 1 are automatically adjusted in position in a plane perpendicular to the first direction with stress generated in the corner section 1e in the elastic deformation.

A molding method of molding the molded body 30 by sandwiching and pressing the molding material 31 between the first mold 10 and the second mold 20 can be an aspect of the present disclosure. The molding method includes a step of disposing the heated and softened molding material 31 between the first mold 10 and the second mold 20 fit and inserted into the cylindrical body mold 1. The molding method further includes a step of moving the first mold 10 in the first direction with respect to the disposed molding material 31 to fit and insert the first mold 10 into the body mold 1 and sandwiching and pressing the molding material 31 with the first mold 10 and the second mold 20. The body mold 1 used in the molding method includes the corner section 1e on the fitting surface with the first mold 10. The first mold 10 includes the inclined surface (10d) in contact with the corner section 1e. In the pressing step described above, the first mold 10 moves in a state in which the corner section 1e of the body mold 1 and the inclined surface (10d) of the first mold 10 are in contact, whereby the center axis AX1 of the first mold 10 and the center axis AX2 of the body mold 1 are aligned. In the molding method, the contact section of the body mold 1 with the first mold 10 viewed from the first direction is provided in one of a circular shape (1e) and an arcuate shape (1e-3f1 to 3f3).

In the molding method described above, at least a part of the corner section 1e can be provided at a position facing the inclined surface (10d) of the first mold 10 in the direction in which the center axis AX2 of the body mold 1 extends. In the molding method described above, it is preferable that the first spacer 40 is disposed between the body mold 1 and the first mold 10 and a predetermined pressing load for molding is applied to the first spacer 40 to elastically deform the first spacer 40 in a range of 0.5 μm to 300 μm. Further, in the molding method described above, it is preferable that the second spacer 80 is disposed at the end portion in the Z minus direction of the second mold 20. When these spacers are provided, the molding method can further include a step of replacing the first spacer 40 to change thickness and adjusting a contact position of the first mold 10 and the body mold 1 at the time when the first mold 10 is brought into contact with the first spacer 41. Further, in such a case, the molding method can further include a step of replacing the second spacer 80 to change the thickness to adjust the thickness of the molded body 30.

In the molding method described above, the second spacer 80 can be disposed at the end portion in the Z minus direction of the second mold 20. In such a case, the temperature of the first mold 10, the second mold 20, the body mold 1, the first spacer 40 and the second spacer 80 can be raised to change the thickness. The molding method can include a step of adjusting, in response to the change in the thickness by thermal expansion, a contact position of the first mold 10 and the body mold 1 at the time when the first mold 10 is brought into contact with the first spacer 40 and adjusting the thickness of the molded body 30 as well. The molding method described above may include a step of adjusting the thickness of the molded body 30 and a step of adjusting the contact position of the first mold 10 and the body mold 1. In this case, the step of adjusting the thickness of the molded body 30 can be performed by replacing the second spacer 80 to change the thickness. The step of adjusting the contact position of the first mold 10 and the body mold 1 can be performed by applying a pressing load to the first spacer 40 to change the thickness.

A molding method of molding the optical member (30) by sandwiching and pressing the optical material (31) between the first mold 10 and the second mold 20 can also be an aspect of the present disclosure. The molding method includes a step of disposing the heated and softened optical material (31) between the first mold 10 and the second mold 20 fit and inserted into a body mold including a fitting and inserting section. The molding method can further include a step of fitting and inserting the first mold 10 into the body mold 1 by moving the first mold 10 in the first direction with respect to the disposed optical material (31). Thereafter, the optical member (30) can be molded from the optical material (31) by sandwiching and pressing the optical material (31) with the first mold 10 and the second mold 20. The inclined surface (10d) can be provided in the first mold 10 used in the molding method. The inclined surface (10d) can be configured to decrease in distance from the center axis toward a direction closer to the body mold 1 in the first direction. The corner section 1e can be provided in the body mold 1. The corner section 1e is formed by two surfaces (the inner circumferential surface of the convex section 1a and the Z plus direction end face of the convex section 1a) that extend respectively at different angles and intersect in the body mold 1 with respect to the inclined surface (10d) and is disposed to face the inclined surface (10d) in the first direction. When the first mold 10 is fit and inserted into the body mold 1, the inclined surface (10d) comes into contact with the corner section 1e and the center axis AX2 of the body mold 1 and the center axis AX1 of the first mold 10 are automatically aligned by stress generated when the inclined surface (10d) elastically deforms the corner section 1e.

With one of the molding apparatuses and the molding methods according to the aspects of the present disclosure described above, when the optical element (the molded body 30) are continuously molded and mass-produced, it is possible to reduce optical axis deviation of an optical element such as a lens that can occur due to the continuous molding.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions. The embodiments and the modifications described above are combined as appropriate without departing from the gist of the present disclosure.

This application claims the benefit of Japanese Patent Application No. 2024-221900, filed Dec. 18, 2024, which is hereby incorporated by reference herein in its entirety.

What is claimed is:

1. A molding apparatus comprising:
a first mold;
a second mold; and
a body mold into which the first mold and the second mold are fit and inserted, wherein
the body mold includes a corner section on a fitting surface with the first mold,
the first mold includes an inclined surface that is in contact with the corner section,
when the first mold is moved in a first direction and a molding material is sandwiched between the first mold and the second mold to mold a molded body, a center axis of the first mold and a center axis of the body mold are aligned by the first mold moving in a state in which the corner section of the body mold and the inclined surface of the first mold are in contact, and
a contact section of the corner section of the body mold with the first mold viewed in the first direction is provided in one of a circular shape and an arcuate shape.

2. The molding apparatus according to claim 1, wherein at least a part of the corner section is provided at a position facing the inclined surface of the first mold in a direction in which the center axis of the body mold extends.

3. The molding apparatus according to claim 1, wherein the corner section is formed by, in a cross section along the center axis of the body mold, the fitting surface and a surface intersecting the fitting surface at an angle different from an angle of the inclined surface.

4. The molding apparatus according to claim 1, wherein the corner section of the body mold viewed from the first direction is provided over an inner circumference of the fitting surface of the body mold.

5. The molding apparatus according to claim 1, further comprising a first spacer disposed between the body mold and the first mold, wherein
the first spacer is provided to elastically deform by the first mold applying a predetermined pressing load to the first spacer when the first mold is moved in the first direction and the molding material is sandwiched between the first mold and the second mold to mold the molded body.

6. The molding apparatus according to claim 5, wherein the first spacer is provided to elastically deform in a range of 0.5 μm or more and 300 μm or less in the first direction.

7. The molding apparatus according to claim 5, wherein
when an inner diameter of the corner section in contact with the inclined surface is Rc,
when a distance, viewed from the first direction, from a position where an outer diameter of the inclined surface of the first mold is Rc to a contact surface with the first spacer is represented as La, and
a distance from a position where an inner diameter of the corner section in contact with the inclined surface of the body mold is Rc to the contact surface with the first spacer in the first direction is represented as Lc,
thickness td of the first spacer satisfies td≤La−Lc.

8. The molding apparatus according to claim 1, wherein the first mold and the body mold are made of different kinds of materials.

9. The molding apparatus according to claim 1, wherein the second mold has a larger coefficient of thermal expansion than the body mold.

10. The molding apparatus according to claim 1, wherein the inclined surface has a truncated cone shape.

11. The molding apparatus according to claim 5, further comprising a second spacer disposed at an end portion of the second mold, wherein
when thickness in a center axis direction of the first mold is ta,
thickness of the second mold in a center axis direction of the body mold is tb,
thickness in the center axis direction of the body mold is tc,
thickness of the first spacer in the first direction is represented as td, and
thickness of the molded body in the first direction is tf,
thickness of the second spacer te satisfies te=(tc+td)−(ta+tb+tf).

12. The molding apparatus according to claim 11, wherein the first spacer and the second spacer is detachably attachable to the first mold and the second mold and the body mold.

13. The molding apparatus according to claim 11, wherein
the first spacer has a smaller coefficient of thermal expansion than at least one of the first mold and the body mold,
when a coefficient of thermal expansion of the first mold is αa,
a coefficient of thermal expansion of the second mold is αb,
a coefficient of thermal expansion of the body mold is αc, and
a coefficient of thermal expansion of the first spacer is αd,
a coefficient of thermal expansion αe of the second spacer satisfies αe={(ac×tc+αd×td)−(αa×ta+αb×tb)}/te.

14. The molding apparatus according to claim 11, wherein
the first spacer has a smaller modulus of longitudinal elasticity than the body mold, and
the second spacer is detachably attachable to the second mold and the body mold.

15. A molding apparatus comprising:
a first mold;
a second mold; and
a body mold into which the first mold and the second mold are fit and inserted,
the molding apparatus molding an optical member by moving the first mold in a first direction and sandwiching an optical material between the first mold and the second mold fit and inserted into the body mold, wherein
the first mold includes an inclined surface, a distance of which from a center axis decreases toward a direction closer to the body mold in the first direction, and
the body mold includes a corner section formed by two surfaces extending respectively at different angles in the body mold with respect to the inclined surface and intersecting, the corner section facing the inclined surface in the first direction,
the corner section being configured to come into contact with the inclined surface when the optical material is sandwiched between the first mold and the second mold.

16. The molding apparatus according to claim 15, wherein the corner section is configured such that, when the first mold is moved to come close to a position where the optical material is sandwiched, a top of the corner section comes into contact with the inclined surface first in a cross section along the first direction.

17. The molding apparatus according to claim 15, wherein
the corner section is capable of elastically deforming with a press load applied to the first mold when the optical material is press-molded, and
positions of the first mold and the body mold are adjusted in a plane perpendicular to the first direction with stress generated in the corner section in the elastic deformation.

18. A molding method of sandwiching and pressing a molding material between a first mold and a second mold to manufacture a molded body, the molding method comprising:
disposing the molding material, which is heated and softened, between the first mold and the second mold fit and inserted into a cylindrical body mold; and
moving the first mold in the first direction with respect to the disposed molding material to fit and insert the first mold into the body mold and sandwiching and pressing the molding material with the first mold and the second mold, wherein
the body mold includes a corner section on a fitting surface with the first mold,
the first mold includes an inclined surface that is in contact with the corner section,
in the pressing, a center axis of the first mold and a center axis of the body mold are aligned by the first mold moving in a state in which the corner section of the body mold and the inclined surface of the first mold are in contact, and
a contact section of the corner section of the body mold with the first mold viewed in the first direction is provided in one of a circular shape and an arcuate shape.

19. A manufacturing method for an article, the manufacturing method performing article manufacturing using the molding apparatus according to claim 1.

20. A computer-readable non-transitory recording medium recording a program for causing a computer to execute the molding method according to claim 18.
